(19) United States
(12) Patent Application Publication
(10) Pub. No.: US 2024/0135293 A1
(43) Pub. Date: Apr. 25, 2024

(54) SYSTEMS AND METHODS FOR EXHAUSTION MITIGATION AND ORGANIZATION OPTIMIZATION

(71) Applicant: PTO Genius, LLC, Miami, FL (US)

(72) Inventors: Adam P. Gordon, Miami, FL (US); Ulises I. Orozco, Miami, FL (US)

(21) Appl. No.: 18/490,849

(22) Filed: Oct. 19, 2023

Related U.S. Application Data
(60) Provisional application No. 63/380,790, filed on Oct. 25, 2022.

(51) Int. Cl. G06Q 10/0637

(52) U.S. Cl. CPC G06Q 10/06375

(57) ABSTRACT

A system obtains a request to determine an amount of organizational exhaustion associated with one or more employees. In response, the system queries historical data associated with the one or more employees to obtain quantitative values that provide indications of the amount of the organizational exhaustion. The system aggregates the data and generates one or more recommendations for reducing the among of organizational exhaustion associated with the one or more employees.

### CROSS-REFERENCE TO RELATED APPLICATIONS

The present patent application claims the priority benefit of U.S. provisional patent application No. 63/380,790 filed Oct. 25, 2022, the disclosures of which are incorporated by reference herein.

### FIELD

The present disclosure relates generally to mitigating organizational exhaustion and providing optimizations for reducing the risk of future organizational exhaustion. In one example, the systems and methods described herein may provide an infrastructure to automatically, and in real-time, provide predictive analyses for identifying and addressing organizational exhaustion.

### SUMMARY

Disclosed embodiments provide a framework for mitigating organizational exhaustion and providing optimizations for automatically, and in real-time, providing predictive analytics for dynamically identifying and addressing organizational exhaustion. According to some embodiments, a computer-implemented method is provided. The computer-implemented method comprises querying historical data associated with an organization to retrieve data corresponding to amounts of organizational exhaustion amongst one or more employees associated with the organization. The historical data includes quantitative values corresponding to the amounts of organizational exhaustion amongst the one or more employees. The computer-implemented method further comprises aggregating the data corresponding to the amounts of organizational exhaustion amongst the one or more employees associated with the organization to generate aggregated data. The computer-implemented method further comprises training a machine learning algorithm. The machine learning algorithm is trained using the historical data and historical recommendations for mitigating organizational exhaustion associated with the organization. Further, the historical recommendations correspond to historical amounts of organizational exhaustion associated with the organization. The computer-implemented method further comprises generating one or more recommendations for reducing the amount of organizational exhaustion associated with the one or more employees. The one or more recommendations are generated using the aggregated data as input to the machine learning algorithm. The computer-implemented method further comprises updating the machine learning algorithm. The machine learning algorithm is updated based on the one or more recommendations and changes to the amount of organizational exhaustion associated with the one or more employees.

In some embodiments, the computer-implemented method further comprises processing in real-time communications associated with the one or more employees to determine a set of sentiments associated with the communications. The computer-implemented method further comprises normalizing the set of sentiments to generate a subset of the quantitative values.

In some embodiments, the computer-implemented method further comprises obtaining in real-time service events associated with the one or more employees. The computer-implemented method further comprises calculating a set of scores corresponding to the service events. The computer-implemented method further comprises normalizing the set of scores according to an impact to the organizational exhaustion to generate a subset of the quantitative values.

In some embodiments, the computer-implemented method further comprises obtaining data corresponding to personal time-off benefit requests and to responses to the personal time-off benefit requests. The computer-implemented method further comprises calculating a set of scores corresponding to the personal time-off benefit requests and the responses. The computer-implemented method further comprises normalizing the set of scores according to an impact to the organizational exhaustion to generate a subset of the quantitative values.

In some embodiments, the quantitative values represent employee states. The employee states represent the organizational exhaustion. Further, the employee states are used to define qualitative descriptors that provide indications of the amounts of organizational exhaustion amongst the one or more employees.

In some embodiments, the computer-implemented method further comprises generating the quantitative values. The quantitative values are generated based on events associated with the one or more employees. Further, the quantitative values are generated using a second machine learning algorithm trained using historical events corresponding to employee behavior.

In some embodiments, the data corresponds to a time range for determining the amount of organizational exhaustion associated with the one or more employees. Accordingly, the computer-implemented method further comprises calculating the amount of organizational exhaustion over the time range to aggregate the data.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which a workforce optimization service aggregates quantitative values corresponding to sentiments expressed during employee communications, workforce events, and requested personal time-off data to determine an amount of organizational exhaustion in accordance with at least one embodiment;

FIG. 2 shows an illustrative example of an environment in which a communications system associated with a workforce optimization service processes, in real-time, employee communications from various sources to determine corresponding sentiments used to provide indications of organizational exhaustion in accordance with at least one embodiment;

FIG. 3 shows an illustrative example of an environment in which a workforce event system associated with a workforce optimization service processes real-time time series data to identify events associated with a set of employees to identify any indications of organizational exhaustion in accordance with at least one embodiment;

FIG. 4 shows an illustrative example of an environment in which a personal time-off system associated with a workforce optimization service processes personal time-off benefit requests and corresponding responses to identify any indications of organizational exhaustion in accordance with at least one embodiment;

FIG. 5 shows an illustrative example of an environment in which an optimization system associated with a workforce optimization service aggregates data corresponding to sentiments expressed during employee communications, workforce events, and requested personal time-off data to determine an amount of organizational exhaustion for a workforce over time and to generate recommendations for addressing organizational exhaustion in accordance with at least one embodiment;

FIGS. 6A-6C show an illustrative example of an environment in which various metrics corresponding to identified organizational exhaustion associated with a workforce are provided through one or more interfaces in accordance with at least one embodiment;

FIG. 7 shows an illustrative example of an environment in which a comparison of organizational exhaustion between a manager and a workforce is provided through an interface in accordance with at least one embodiment;

FIG. 8 shows an illustrative example of a process for monitoring employee communications in real-time across different communications channels to identify a set of sentiments associated with the employee communications to determine contributions to organizational exhaustion in accordance with at least one embodiment;

FIG. 9 shows an illustrative example of a process for calculating a set of scores corresponding to employee service events in real-time to determine contributions to organizational exhaustion in accordance with at least one embodiment;

FIG. 10 shows an illustrative example of a process for calculating a set of scores corresponding to employee personal time-off requests in real-time to determine contributions to organizational exhaustion in accordance with at least one embodiment;

FIG. 11 shows an illustrative example of a process for calculating quantitative values representing employee states associated with organizational exhaustion and for determine qualitative descriptors for these quantitative values in accordance with at least one embodiment;

FIG. 12 shows an illustrative example of a process for providing aggregated data corresponding to organizational exhaustion corresponding to a set of employees and recommendations for addressing the organizational exhaustion in accordance with at least one embodiment; and

FIG. 13 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

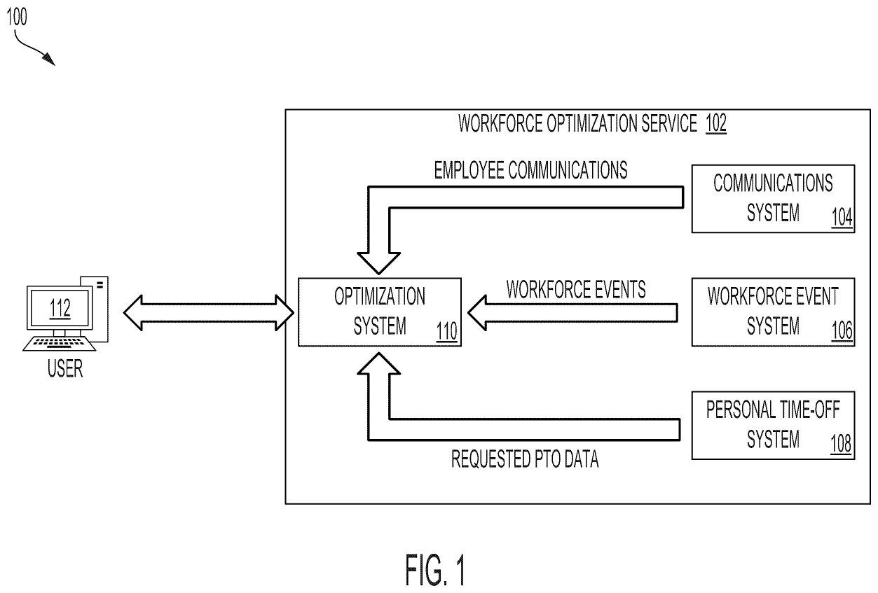

FIG. 1 shows an illustrative example of an environment 100 in which a workforce optimization service 102 aggregates quantitative values corresponding to sentiments expressed during employee communications, workforce events, and requested personal time-off data to determine an amount of organizational exhaustion in accordance with at least one embodiment. In the environment 100, a user 112 associated with an employer or other organization may transmit a request to an optimization system 110 of a workforce optimization service 102 to obtain various metrics associated with an amount of organizational exhaustion associated with the employer or other organization, as well as to obtain any recommendations for addressing this amount of organizational exhaustion. For instance, via a platform implemented by the workforce optimization service 102 for particular users (e.g., managers, executives, administrators, human resources groups, etc.) associated with an employer or organization, the user 112 may select one or more options for viewing different metrics corresponding to the organizational exhaustion associated with particular groups of employees (e.g., key employees, executives, business units or other internal organizations, etc.) or with the employer/organization as a whole. The workforce optimization service 102 may provide a platform for companies (e.g., employers, organizations, etc.) to manage their organizational exhaustion for their employees, while providing various recommendations for addressing any significant issues related to organizational exhaustion. The platform provided by the workforce optimization service 102 may be implemented via an application installed on a computing device (e.g., computer system, smartphone, smartwatch, etc.) or via a website, which may be accessed via a browser application.

In an embodiment, when the user 112 accesses the platform provided by the workforce optimization service 102, an optimization system 110 of the workforce optimization service 102 automatically accesses a cache to obtain historical data that is indicative of organizational exhaustion associated with the employer or organization. The optimization system 110 may be implemented on a computing system or other system (e.g., server, virtual machine instance, etc.) of the workforce optimization service 102. The cache may include organizational exhaustion calculations for the organization or employer over time (e.g., per week, per month, per bi-month, per year, etc.). The organizational exhaustion calculations may be provided on a per employee basis, whereby a particular organizational exhaustion calculation may correspond to a particular employee associated with the organization or employer. An organizational exhaustion calculation may include a quantitative value that represents the state of an employee in terms of their individual level of exhaustion or burnout.

In an embodiment, the optimization system 110 compares the quantitative value representing the state of an employee in terms of their individual level of exhaustion or burnout against a normalization table that indicates the qualitative description for their individual level of exhaustion or burnout. For example, the optimization system 110 may maintain a normalization table that indicates, for individual quantitative value ranges, the corresponding level of exhaustion or burnout that an employee may be experiencing at any given time. As an illustrative example, if the quantitative values are determined within a scoring range that has a minimum possible value of 0 and a maximum possible value of 1,000 (where a higher value denotes a higher level of exhaustion of burnout), the normalization table may define sub-ranges for different exhaustion or burnout categories. For instance, the normalization table may define an “engaged” category corresponding to quantitative values between 0 and 100. The “engaged” category may be used to denote that an employee is energetic, involved, and effective in performing their duties.

The normalization table may further define an “overextended” category corresponding to quantitative values between 101 and 400. The “overextended” category may be used to denote that an employee is experiencing a level of fatigue and may be overworked. However, an employee classified as being “overextended” may still be productive within the workforce. A classification of an employee as being “overextended” may serve as an initial indicator or warning that the employee is within the early or transitional stages of organizational exhaustion or burnout. Further, this classification may denote that employee wellness is beginning to suffer due to the employee having insufficient time or opportunity to recover from their tedium.

The normalization table may further define an “ineffective” category corresponding to quantitative values between 401 and 650. The “ineffective” category may be used to denote that an employee is being less productive within the workforce but potentially has an interest in the organization for which they are performing their duties. Such an employee may be less likely to take advantage of their existing personal time-off benefits due to possible concerns with regard to perception within the workforce. However, an employee categorized as being “ineffective” may be closer to organizational exhaustion or burnout.

The normalization table may further define a “disengaged” category corresponding to quantitative values between 651 and 800. The “disengaged” category may be used to denote that an employee is unproductive, cynical, dissatisfied, and disconnected emotionally, socially, or cognitively. At this point, the employee may begin to self-evaluate their purpose within the workforce or organization and, as a result, the employee may become more jaded towards the workforce or organization. Further, the employee may only be working for their own interests rather than as a team member within the workforce or organization. The employee may no longer has an interest in their growth within the organization and instead sees their employment as a means to an end. The “disengaged” category, thus, may be the final transitional stage of organizational exhaustion or burnout.

A quantitative value between 801 and the maximum possible value of 1,000 may correspond to the “burnout” category within the normalization table. This category may be used to denote an employee that is exhausted, chronically fatigued, cynical, dissatisfied, and ineffective at performing their duties within the organization. Such an employee may have lost their psychological and emotional connection with their work, which may have implications for their motivation and their identity. Further, the employee may lack the energy required to make a useful and enduring contribution to their organization, as the employee may have determined that their contributions to the organization are of little value and significance.

It should be noted that while the aforementioned quantitative value range, normalization table categories, and corresponding sub-ranges for each of these categories are described extensively herein for the purpose of illustration, other parameters may be used to denote a level of organizational exhaustion for employees associated with the workforce or organization. For example, the quantitative value sub-ranges for each of the aforementioned categories may be dynamically changed based on an evaluation of the actual organizational exhaustion of the workforce over time. For instance, if employees categorized as being “disengaged” based on their determined quantitative values are actually exhibiting symptoms of burnout based on various factors (described in greater detail herein), the optimization system 110 may dynamically adjust the sub-ranges for each of the categories such that the minimum quantitative value corresponding to the “burnout” category is lowered to include these employees. As another illustrative example, while organizational exhaustion may be described according to the aforementioned categories, additional and/or alternative categories of organizational exhaustion may be introduced to provide a more granular qualitative description of an employee's level of organizational exhaustion. These additional and/or alternative categories may have corresponding quantitative value sub-ranges to allow for normalization of quantitative values according to these additional and/or alternative categories.

In an embodiment, the optimization system 110 obtains quantitative partial results corresponding to employee communications, workforce events, and requested personal time-off data that may be aggregated to generate the quantitative values used to determine an amount of organizational exhaustion for the workforce or organization and for each employee associated with the workforce or organization. For example, as illustrated in FIG. 1, the workforce optimization service 102 may implement a communications system 104, a workforce event system 106, and a personal time-off system 108 that may be collectively used to automatically, and in real-time, process employee-related data to generate quantitative partial results that, when aggregated, may be used to determine the amount of organizational exhaustion within the workforce or organization and the amount of organizational exhaustion for each employee associated with the workforce or organization.

The communications system 104 may be implemented on a computing system or other system (e.g., server, virtual machine instance, etc.) of the workforce optimization service 102. In an embodiment, the communications system 104 automatically, and in real-time, monitors employee communications in order to identify any indicators of organizational exhaustion. The employee communications may include any communications exchanged within the workforce or organization by an employee through the communications channels provided by the organization. For example, the communications system 104 may automatically, and in real-time, monitor communications exchanged through electronic mail servers, chat sessions, voice conversations (e.g., telephonic and/or Voice over Internet Protocol (VoIP)), and the like. In some instances, the communications system 104 may further automatically, and in real-time, monitor communications exchanged through other electronic mail servers, chat sessions, voice conversations, and the like that are not associated with the organization. For example, subject to employee discretion and approval, the communications system 104 may monitor external communications exchanged by an employee with other entities not associated with the workforce or organization (e.g., friends, family members, etc.) to obtain additional information that may be used to determine a contribution to the employee's level of organizational exhaustion over time.

In an embodiment, the communications system 104 may process these communications in real-time using a machine learning algorithm or artificial intelligence to determine the employee sentiment for each of these communications. As described in greater detail herein, employee sentiment may serve as an indicator of the employee's current level of organizational exhaustion. For instance, an employee that continuously expresses frustration or disappointment in the performance of their duties may be exhibiting a higher level of organizational exhaustion. As another illustrative example, an employee that expresses elation over a promotion or other achievement may be exhibiting a lower level of organizational exhaustion for a period of time. As yet another illustrative example, any communication whereby the employee is experiencing a traumatic event (e.g., loss of a family member or friend, divorce, financial burden, etc.) may be indicative of the employee experiencing a higher level of organizational exhaustion. Thus, the machine learning algorithm or artificial intelligence may be dynamically trained to determine the employee sentiment behind any communication exchanged by the employee to any other entity.

The machine learning algorithm or artificial intelligence may be dynamically trained to perform a semantic analysis of communications exchanged via the one or more communications channels associated with the workforce or organization and/or the one or more communications channels that are not associated with the workforce or organization (subject to employee approval). For instance, the machine learning algorithm or artificial intelligence may be dynamically trained to identify keywords, sentence structures, repeated words, punctuation characters and/or non-article words, and the like in order to identify the employee sentiment expressed in a communication. The machine learning algorithm or artificial intelligence implemented by the communications system 104 may be dynamically trained using supervised learning techniques. For instance, a dataset of input communications and known sentiments expressed in the input communications can be selected for training of the machine learning algorithm or artificial intelligence. In some embodiments, known sentiments used to train the machine learning algorithm or artificial intelligence may include characteristics of these sentiments. The machine learning algorithm or artificial intelligence may be evaluated to determine, based on the input sample communications supplied to the machine learning algorithm or artificial intelligence, whether the machine learning algorithm or artificial intelligence is extracting the expected sentiments from each of these communications. Based on this evaluation, the machine learning algorithm or artificial intelligence may be modified or re-trained to increase the likelihood of the machine learning algorithm or artificial intelligence generating the desired results (e.g., identifying and extracting the correct sentiment from the communication). The machine learning algorithm or artificial intelligence may further be dynamically trained by soliciting feedback from users, including user 112 and employees associated with the workforce or organization, with regard to the extracted sentiments obtained from exchanged communications.

In an embodiment, the machine learning algorithm or artificial intelligence is implemented using Natural Language Processing (NLP), which can identify the keywords, sentence structures, repeated words, punctuation characters and/or non-article words and the like expressed within each communication in real-time. The machine learning algorithm or artificial intelligence, through use of NLP, may assign a confidence score for each possible sentiment that may be expressed within the communication. For example, if an employee expresses dissatisfaction with a particular task or assignment through a communication exchanged with another employee, the machine learning algorithm or artificial intelligence may assign a higher confidence score to negative sentiments as opposed to other forms of sentiments (e.g., mixed sentiments, positive sentiments, neutral sentiments, etc.). These confidence scores may be used as a weight or factor that may be applied to the particular sentiment used to determine the quantitative partial result corresponding to the employee's level of organizational burnout. Additionally, for a particular sentiment, the machine learning algorithm or artificial intelligence may dynamically determine the magnitude of the particular sentiment within the communication. The magnitude, along with the confidence score, for the particular sentiment may be used to assign a quantitative partial result for the communication.

As an illustrative example, the communications system 104 may identify, in real-time through the machine learning algorithm or artificial intelligence, any communications that may be indicative of the quality and quantity of tools that an employee may use to perform assigned tasks. The machine learning algorithm or artificial intelligence may process these communications to identify employee sentiment with regard to the quality and quantity of these tools. As being provided with inferior or ineffective tools may result in a degradation of the employee's performance and, thus, increase organizational exhaustion, the machine learning algorithm or artificial intelligence may assign a negative polarity (e.g., score or other metric) to any communications where the employee expresses frustration, disappointment, or other similar sentiment with regard to these tools.

As another illustrative example, the communications system 104, through the machine learning algorithm or artificial intelligence, may process communications exchanged amongst employees associated with a particular role (e.g., a product team, an internal organization, a business unit, etc.) to determine a sentiment for each of these employees and a corresponding score or other metric for the sentiment. The communications system 104, based on these scores or other metrics, may calculate an average sentiment score or metric for the particular role. For each employee associated with the particular role, the communications system 104 may consider any statistical deviation from the average sentiment score or metric as this may be indicative of a change in sentiment for the employee and, thus, may be indicative of a change in the employee's organizational exhaustion.

In some instances, the communications system 104 may process communications (e.g., chat sessions, electronic mail messages, social media messages, intranet communications, etc.) to identify any public recognition associated with an employee. Public recognition may be provided in the form of complimentary remarks, monetary or other rewards, certificates or other official acknowledgment of an accomplishment, and the like. The machine learning algorithm or artificial intelligence may measure the sentimental state from these communications, as the sentimental effect of public recognition may, in some instances, reduce the organizational exhaustion of an employee. However, this measurement of the employee's sentiment based on public recognition may be tailored such that, over time, the impact to the employee's organizational exhaustion is decreased. In some instances, to ensure that this measurement decreases over time, the communications system 104 may dynamically apply a weighting factor that is automatically reduced based on the amount of time that has elapsed since the public recognition was given to the employee.

The communications system 104 may further process any communications corresponding to any personal events associated with an employee to determine the sentimental impact to the employee's organizational exhaustion. For example, the communications system 104, through the machine learning algorithm or artificial intelligence, may measure the quantity of communications initiated by colleagues and/or by the organization corresponding to recognition of an employee's personal event (e.g., a birthday, a graduation, an anniversary, etc.). The presence and quantity of such communications may provide a positive polarity towards an employee's sentiment towards the organization and their place within the organization. Alternatively, the absence of such communications may indicate a lack of recognition of the employee's personal event, thereby providing a negative polarity towards the employee's sentiment. As another illustrative example, if the employee has suffered a personal tragedy (e.g., a loss in the family, etc.), the communications system 104, through the machine learning algorithm or artificial intelligence, may measure the quantity of communications initiated by colleagues and/or by the organization providing their condolences. While the personal tragedy may serve as a negative contributor to the employee's organizational exhaustion, these communications may provide a positive polarity towards the employee's sentiment towards the organization and, thus, provide a counterbalance to the negative impact of the personal tragedy.

The communications system 104 may further evaluate the communications exchanged by an employee to determine the employee's level of interaction with their colleagues and, based on these communications, determine the employee's sentiment. The communications system 104, through the machine learning algorithm or artificial intelligence, may measure the sentimental state from any interaction (through any available communications channel) with the employee's colleagues or other entities associated with an organization. The corresponding score or metric corresponding to the employee's sentimental state may be scaled according to the volume of communications between the employee and their colleagues or other entities, as well as according to the number of entities involved in each communication.

In an embodiment, the communications system 104, through the machine learning algorithm or artificial intelligence, can further process the communications exchanged by an employee to detect any communications that are indicative of the employee's desire to depart from the organization or that are otherwise indicative of their sentiment with regard to the organization that the employee is a part of. For example, if an employee expresses frustration at being unable to go on vacation as a result of a major assignment, the machine learning algorithm or artificial intelligence may assign a negative polarity to such a communication and, thus, assign a negative score or metric for the employee's particular sentiment. A similar negative polarity may be assigned to communications where the employee is denied a request to use their personal time-off benefits for a special event or other event that the employee has ascribed a high importance to.

In addition to evaluating communications exchanged by an employee over a period of time and/or in real-time as these communications are exchanged, the communications system 104 may further determine the frequency and/or volume of communications exchanged between the employee and other entities associated with their organization and/or group. For instance, if an employee is transmitting and/or receiving a significant number of communications over a short period of time, this may denote an elevated amount of work for the employee, which may serve as a possible indicator of increased organizational exhaustion. In an embodiment, the communications system 104 (independently or in conjunction with the workforce event system 106 as described in greater detail herein) can further correlate the frequency and/or volume of communications to periods of time during which the employee is expected to not be subject to significant volumes of work (e.g., holidays, weekend days, designated personal time-off periods, etc.). For instance, if the frequency and/or volume of communications associated with an employee does not change or increases during known periods of respite for the employee, the communications system 104 may determine that the employee's workload has not reduced during these known periods of respite. This may serve as a possible indicator of elevated organizational exhaustion as the employee is unable to take advantage of their periods of supposed respite.

The communications system 104 may further evaluate the communications exchanged by an employee over a period of time and/or in real-time to determine the times at which these communications were exchanged. For example, if an employee is transmitting communications outside of their defined work schedule (e.g., the employee is transmitting communications in the middle of the night, etc.), the communications system 104 may determine that the employee is not taking advantage of their periods of rest. The communications system 104 may further use the aforementioned data corresponding to the frequency and/or volume of communications associated with the employee to determine whether the employee has established a routine of transmitting communications outside of their defined work schedule.

In an embodiment, the communications system 104 may aggregate the various scores or metrics corresponding to an employee's sentiment expressed in the communications exchanged over a particular period of time and determine an average sentiment score or metric that may be used to determine the employee's organizational exhaustion over this particular period of time. This process may result in a normalization of the employee's sentiment over the particular period of time. As noted above, the optimization system 110 may obtain quantitative partial results corresponding to employee communications, workforce events, and requested personal time-off data that may be aggregated to generate the quantitative values used to determine an amount of organizational exhaustion for the workforce or organization and for each employee associated with the workforce or organization. Accordingly, the normalized sentiment score or metric for the employee may be adjusted according to a factor or weight determined based on the contribution of the employee's sentiment to the overall organizational exhaustion for the employee. For example, if employee sentiment accounts for 30% of an employee's organizational exhaustion (e.g., the sentiment may account for a maximum of 300 points from the maximum possible organizational exhaustion score of 1,000 points, etc.), the communications system 104 may apply a factor or weight to the normalized sentiment score or metric such that the resulting quantitative partial result corresponding to an employee's sentiment is within a range of −30% to 30% of the possible organizational exhaustion for the employee (e.g., −300 to 300 points). The resulting quantitative partial result may be negative, as a positive employee sentiment may provide a positive impact against organizational exhaustion, thereby reducing the employee's overall organizational exhaustion score or metric.

The workforce event system 106 may be implemented on a computing system or other system (e.g., server, virtual machine instance, etc.) of the workforce optimization service 102. In an embodiment, the workforce event system 106 obtains data, in real-time, from one or more employer systems corresponding to employee events occurring within the organization that may have an impact on an employee's organizational exhaustion. For instance, the data may include time series data corresponding to the time elapsed between clock-in and clock-out events for an employee over a particular period of time (e.g., weekly, monthly, etc.). This time series data may further include any periods of rest between clock-in and clock-out events, whereby an employee may enjoy a break period during workdays, not including any usage of personal time-off benefits. This time series data may be compared to known employee work schedules such that the workforce event system 106 may automatically, and in real-time, determine when an employee is working beyond their defined work schedule and/or has continued to work without a break period.

In an embodiment, the workforce event system 106 can cross-reference the time series data with organization and employee calendars to determine if an employee is working on holidays, during blackout periods, during a schedule vacation or other personal time-off period, or otherwise outside of their regular or formal schedule. Additionally, the workforce event system 106 can cross-reference time series data with organization and employee calendars to determine if an employee is working during periods in which other employees within the particular employee's group are taking personal time-off. For instance, the workforce event system 106 may automatically process any employee communications (in conjunction with the communications system 104 or independently) to identify any communications that are indicative of an employee performing any tasks outside of their regular/formal schedule or during a scheduled time off. Further, the workforce event system 106 may automatically process any employee communications (in conjunction with the communications system 104 or independently) to identify any communications that are indicative of an employee performing any tasks on behalf of other employees that are taking personal time-off, thereby increasing the employee's workload.

In an embodiment, the workforce event system 106 can further obtain data, in real-time, corresponding to any overarching organizational or employee group events that may have an impact on an employee's organizational exhaustion. As an illustrative example, the workforce event system 106 may automatically process any employee communications (in conjunction with the communications system 104 or independently) to identify any communications that are indicative of workforce reductions (e.g., layoffs, furloughs, etc.) affecting an employee's organization. These workforce reductions may signal increased organizational exhaustion for an employee, particularly if the employee is communicating their concerns with potentially being subject to these workforce reductions. Additionally, or alternatively, these workforce reductions may further signal increased organization exhaustion for an employee if the employee is required to perform additional tasks on behalf of other employees that were subject to these workforce reductions.

If the workforce event system 106 independently processes these employee communications, the workforce event system 106 may implement a machine learning algorithm or artificial intelligence using NLP to identify the keywords, sentence structures, repeated words, punctuation characters and/or non-article words and the like expressed within each communication in real-time to detect when an employee is performing any tasks outside of their regular/formal schedule or during a scheduled time off. For example, the machine learning algorithm or artificial intelligence may be dynamically trained to perform a semantic analysis of these communications to identify any indications of an employee performing tasks outside of their regular/formal schedule or during a scheduled time off. The machine learning algorithm or artificial intelligence utilized by the workforce event system 106 may be dynamically trained using supervised learning techniques. For instance, a dataset of input communications, employee schedules, and known indicators of task performance expressed in these input communications can be selected for training of the machine learning algorithm or artificial intelligence. The machine learning algorithm or artificial intelligence may be evaluated to determine, based on the input sample communications and employee schedules supplied to the machine learning algorithm or artificial intelligence, whether the machine learning algorithm or artificial intelligence is accurately identifying when an employee is performing a work-related task outside of their known schedule or during a scheduled time off. Based on this evaluation, the machine learning algorithm or artificial intelligence may be modified to increase the likelihood of the machine learning algorithm or artificial intelligence generating the desired results. The machine learning model may further be dynamically trained by soliciting feedback from user 112 with regard to the determinations made from submitted communications and corresponding schedules.

In some instances, the workforce event system 106 may further evaluate the workforce associated with each employee (e.g., product team, internal organization, business unit, etc.) to measure any discrepancies between the number of current, active employees within the workforce and the required number of active employees. For example, if a particular product team is understaffed, an employee within this particular product team may be more prone to experiencing organizational exhaustion as opposed to another employee within a different product team that is fully or adequately staffed. The workforce event system 106 may further measure the quantity of activities per employee while taking into consideration the employee's role within the organization. For instance, the workforce event system 106 may measure the number and complexity of these activities over a period of time given the employee's assigned role. For example, if the employee has been assigned a significant number of complex tasks that are not usually within the ambit of the employee's responsibilities, this may serve as an indication that the employee is more likely to experience organizational exhaustion over this period of time.

The workforce event system 106 may additionally evaluate employee wages as a function of an individual employee's wage compared to that of their co-workers and other similarly-situated employees within other similar organizations (e.g., employees associated with other employers, employees sharing similar job titles/roles/codes/etc. and associated with a common employer and/or other employers, etc.). For example, the workforce event system 106, for a particular employee, may measure the employee's wage based on their role and against wages associated with their colleagues within the organization and other similarly-situated organizations (e.g., other companies having similar employee roles, etc.). Any deviations in wages may be evaluated according to the employee's appreciation of their present wage, whereby employee sentiment (as determined through the communications system 104) may be used as a factor or weight in adjusting any score or metric associated with such wage deviations.

Additionally, the workforce event system 106 may determine whether an employee has received a salary increase over a particular period of time, which may be indicative of a reduction in the organizational exhaustion of the employee. For instance, the workforce event system 106 may compare an employee's wage during a previous period of time (e.g., previous month, etc.) to the employee's present wage to identify any increases in the employee's wage. If an increase is detected, the workforce event system 106 may assign a score that is tailored such that, over time, the impact to the employee's organizational exhaustion is decreased. In some instances, to ensure that this score decreases over time, the workforce event system 106 may dynamically apply a weighting factor that is automatically reduced based on the amount of time that has elapsed since the change to the employee's wage.

In an embodiment, the workforce event system 106 further evaluates the time series data from the one or more employer systems to measure the elapsed time between the start of employee activities or tasks and the end or change in status of these employee activities or tasks in order to identify any employee delays in the performance of these activities or tasks. For example, the workforce event system 106 may compare the elapsed time in performance of an activity or task to the expected amount of time required for performance of the activity or task. The expected amount of time may be determined based on schedules or calendars maintained by the organization (e.g., Gantt charts, project schedules, scrum boards, Kanban boards, etc.). In some instances, the workforce event system 106 may use a machine learning algorithm or artificial intelligence to determine an estimated amount of time for completion of an activity or task. For example, the workforce event system 106 may execute one or more clustering algorithms, such as K-means clustering, means-shift clustering, Density-Based Spatial Clustering of Applications with Noise (DBSCAN) clustering, Expectation-Maximization (EM) Clustering using Gaussian Mixture Models (GMM), and other suitable machine learning algorithms on datasets comprising previously performed activities or tasks in order to generate clusters corresponding to different activity or task types. Based on a set of characteristics of the particular activity or task, the workforce event system 106 may identify a particular cluster of similar activities or tasks, from which the workforce event system 106 may automatically determine an estimated amount of time for completion of the activity or task. Based on any identified deviations between the elapsed time for performance of an activity or task and the expected time required for completion of the activity or task, the workforce event system 106 may assign a score or measurement that may correspond to an amount of organizational exhaustion resulting from delays in performance of the activity or task. This score or measurement may be dynamically adjusted based on one or more factors including, but not limited to, the complexity or difficulty of the activity or task.

In addition to identifying any delays in the performance of an activity or task, which may have a negative impact on organizational exhaustion, the workforce event system 106 may identify, from the time series data and/or from other data obtained from the one or more employer systems, the quantity of errors and rollbacks associated with activities or tasks resulting from failure to satisfy established criteria for performance of these activities or tasks. Based on the quantity of errors and rollbacks associated with these activities or tasks, the workforce event system 106 may determine a rate of errors and rollbacks over a period of time. A higher rate of error may correspond with a higher level of organizational exhaustion and, thus, may be assigned a higher score that may be used to determine the overall organizational exhaustion for employees associated with these activities or tasks.

In an embodiment, the workforce event system 106 can further process other time series data that may denote the impact of employee commutes to employee organizational exhaustion. For example, employees associated with the employer or organization may be provided with an opportunity to opt-in to provide location data that may be used to determine their relative daily commutes. For instance, an employee that has a significant commute time (as determined through time series data obtained from the employee's mobile device or application that tracks employee location) may experience increased organizational exhaustion as the addition of a lengthy commute to an existing work schedule may result in less time for employee downtime. In some instances, the workforce event system 106 may combine the detected commute time for an employee with the overall density of their work schedule to determine the total amount of downtime the employee may have on any given day. The workforce event system 106 may compare this total amount of downtime for the employee to that of the employee's organization and/or group to determine whether the employee has less downtime available compared to their peers. This may signal a likelihood of increased organizational exhaustion for the employee.

The workforce event system 106, in an embodiment, processes the various scores and metrics corresponding to the measurements described above using linear normalization to generate a quantitative partial result corresponding to the impact these particular workforce events have had on employees' organizational exhaustion over a period of time. For example, if the workforce events described above account for 20% of an employee's organizational exhaustion (e.g., the workforce events may account for a maximum of 200 points from the maximum possible organizational exhaustion score of 1,000 points, etc.), the workforce event system 106 may apply a factor or weight to each normalized event score or metric such that the resulting quantitative partial result corresponding to events associated with an employee is within a range of 0% to 20% of the possible organizational exhaustion for the employee (e.g., 0 to 200 points).

In addition to the quantitative partial results from the communications system 104 and the workforce event system 106, the optimization system 110 may obtain a quantitative partial result from a personal time-off system 108. The personal time-off system 108 may be implemented on a computing system or other system (e.g., server, virtual machine instance, etc.) of the workforce optimization service 102. In an embodiment, the personal time-off system 108 obtains data, in real-time, from one or more employer systems corresponding to requests to utilize personal time-off benefits allocated for employees associated with an organization. The one or more employer systems may include a human resources system (HRS) (e.g., human resources information system (HRIS), human resource management systems (HRMS), human capital management system (HCMS), etc.) or an HRS provider utilized by an employer.

In an embodiment, the personal time-off system 108 evaluates the obtained data to determine, for each employee, the last time a request to utilize a personal time-off benefit was approved. For instance, the personal time-off system 108 may identify, from the obtained data, any communications or entries corresponding to an administrative approval of an employee request for time off from work. This may include approvals for personal time-off associated with vacations, rest days, family leave, and the like. As the amount of time from the previously approved request increases, the personal time-off system 108 may assign an increasing score or metric that may be indicative of an employee's lack of personal time-off over time. This lack of personal time-off may serve as an indicator of possible fatigue, which may result in greater organizational exhaustion for the employee.

Additionally, the personal time-off system 108 may evaluate the obtained data to identify any unscheduled and/or extra personal time-off provided to an employee over a period of time. For instance, the personal time-off system 108 may determine the amount of additional time-off provided to an employee during a particular time period and provided outside of the traditional amount of personal time-off that is assigned to the employee or that the employee otherwise has accrued over time. This additional time-off may be provided, for example, as a result of a sudden event that requires the employee to be away from their employment (e.g., a death in the family, a family emergency, a medical issue, etc.). The impact of this additional time-off to an employee's organizational exhaustion may be determined based on any communications exchanged by the employee with others within the organization and other entities, such as through the communications system 104 described above. For example, if the employee expresses, subsequent to taking an unscheduled and/or extra period of time away from work, that the employee is feeling refreshed or is otherwise grateful for having taken the additional time-off, the personal time-off system 108 may assign a positive polarity to this extra time-off. As another illustrative example, if the employee expresses that they had to take an extra amount of time-off from work due to a high level of stress and/or anxiety related to their work performance, the personal time-off system 108 may assign a negative polarity to this extra time-off, as this extra time-off had to be taken in order to address the employee's high level of organizational exhaustion.

The personal time-off system 108 may further determine, from the obtained data, the number of denied requests for time-off during a period of time for which the requests were submitted for important events associated with the employee. For example, the personal time-off system 108 may process the obtained data to identify any rejected requests for personal time-off, including any dates corresponding to when these requests were submitted and to when these requests were rejected. Based on these dates, the personal time-off system 108 may identify any communications corresponding to the submission and rejection of these requests. For example, through the communications system 104, the personal time-off system 108 may identify any communications that may provide indications as to why the personal time-off was requests as well as the sentiment of the employee upon being informed of the rejection of these requests. A negative sentiment may result in the personal time-off system 108 assigning a higher organizational exhaustion score or metric to the rejected personal time-off request, with the impact of the rejection (and the score) diminishing over time.

Additionally, the personal time-off system 108 may evaluate the obtained data to identify the quantity of times that personal time-off requests submitted by an employee were denied in a row. For instance, the personal time-off system 108 may count the number of denied time-off requests in a row and weigh these exponentially, with each denied request exponentially increasing the corresponding score or metric associated with the contribution of these denied requests to the employee's organizational exhaustion. In some instances, this score or metric may be dynamically adjusted based on the subsequent behavior of the employee, as not all employees may require or have the same perception regarding use and/or rejection of time-off requests.

In an embodiment, the personal time-off system I 108 can evaluate the obtained data for a set of employees associated with a particular group or organization to identify any possible inequities within the group or organization that may serve as drivers for increased organizational exhaustion. For instance, the personal time-off system 108 may process the obtained data through a recurrent neural network (RNN) or a convolutional neural network (CNN) to predict correlations between employee usage of personal time-off benefits within an employee group or organization and possible inequities whereby one or more employees may be favored over others when granting time-off requests. For example, through the RNN or CNN, the personal time-off system 108 may determine whether a particular manager within an employee group or organization is favoring one or more employees over other employees within the employee group or organization by inordinately approving time-off requests from these one or more employees while continually refusing time-off requests from other employees. This detected favoritism may result in increased organizational exhaustion amongst the other employees and, accordingly, the employee group or organization. As another illustrative example, through the RNN or CNN, the personal time-off system 108 may determine whether a particular manager within an employee group or organization is rejecting time-off requests of employees associated with an affinity group. This may serve as an indication of possible discrimination within the employee group or organization, which may significantly increase the level of organizational exhaustion amongst these employees.

The personal time-off system 108, in an embodiment, processes the various scores and metrics corresponding to the measurements described above using linear normalization to generate a quantitative partial result corresponding to the impact that the utilization of time-off benefits (or lack thereof) have had on employees' organizational exhaustion over a period of time. For example, if the lack of usage of allocated time-off benefits described above account for 50% of an employee's organizational exhaustion (e.g., the lack of usage of time-off benefits may account for a maximum of 500 points from the maximum possible organizational exhaustion score of 1,000 points, etc.), the personal time-off system 108 may apply a factor or weight to each normalized event score or metric such that the resulting quantitative partial result corresponding to the lack of usage of time-off benefits is within a range of 0% to 50% of the possible organizational exhaustion for the employee (e.g., 0 to 500 points).

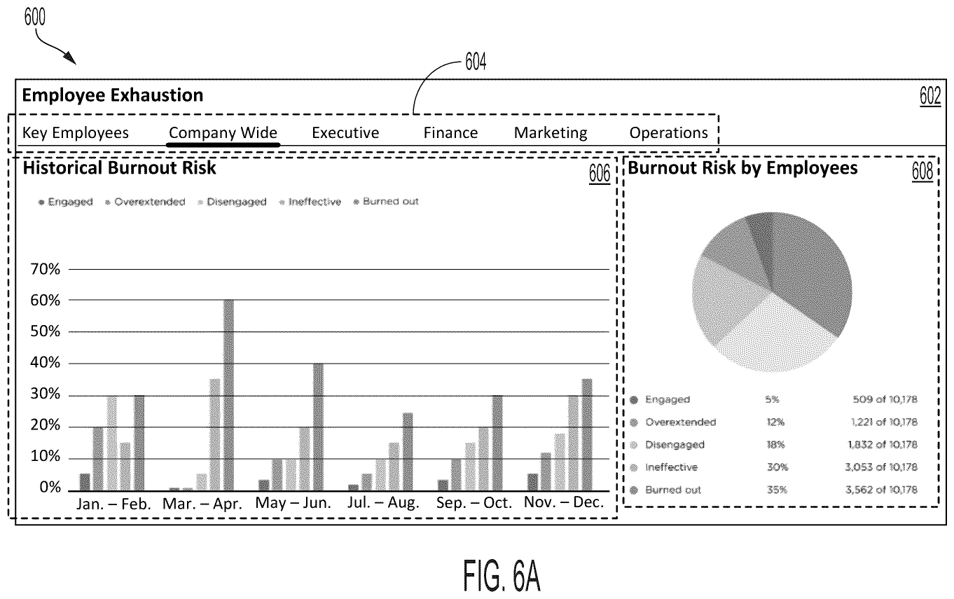

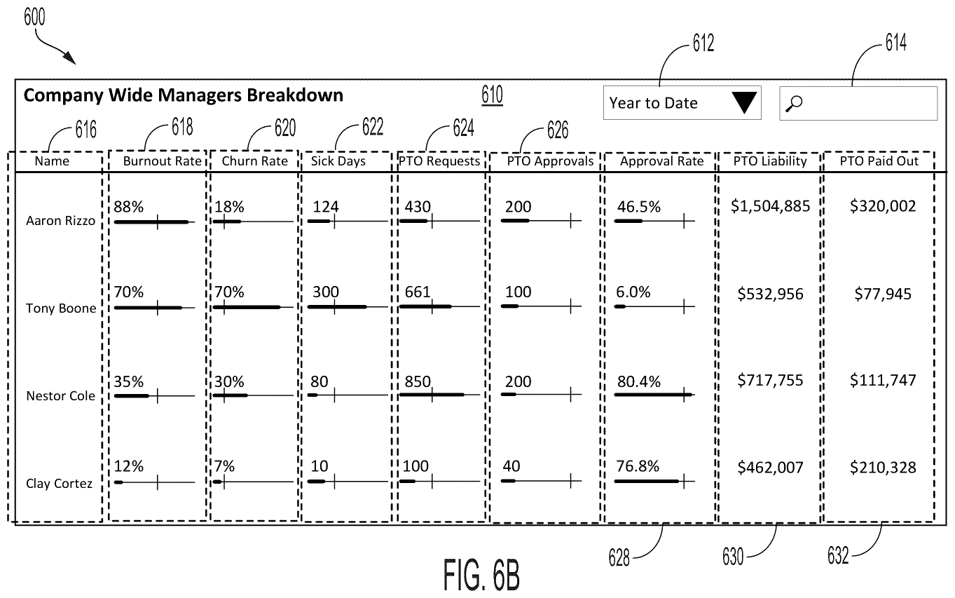

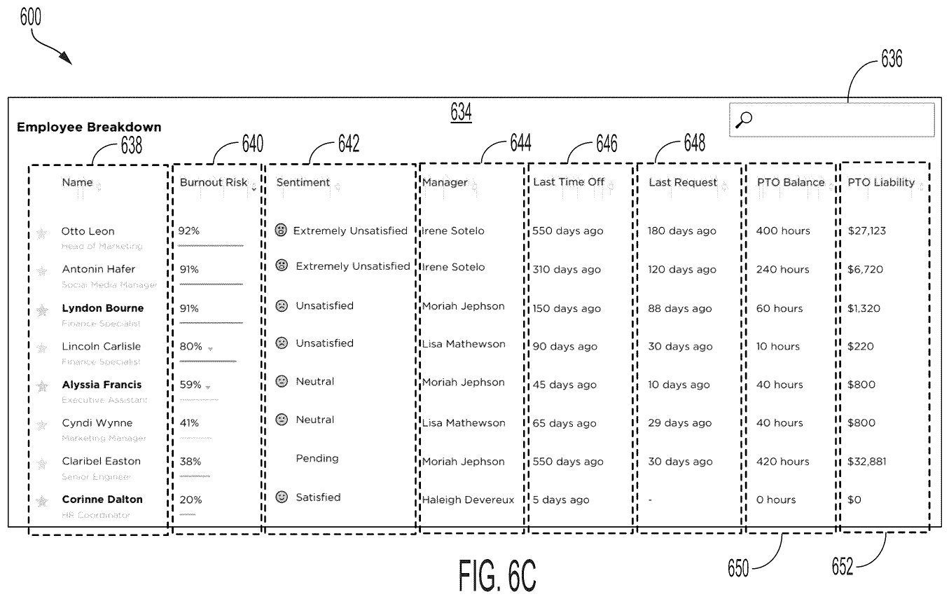

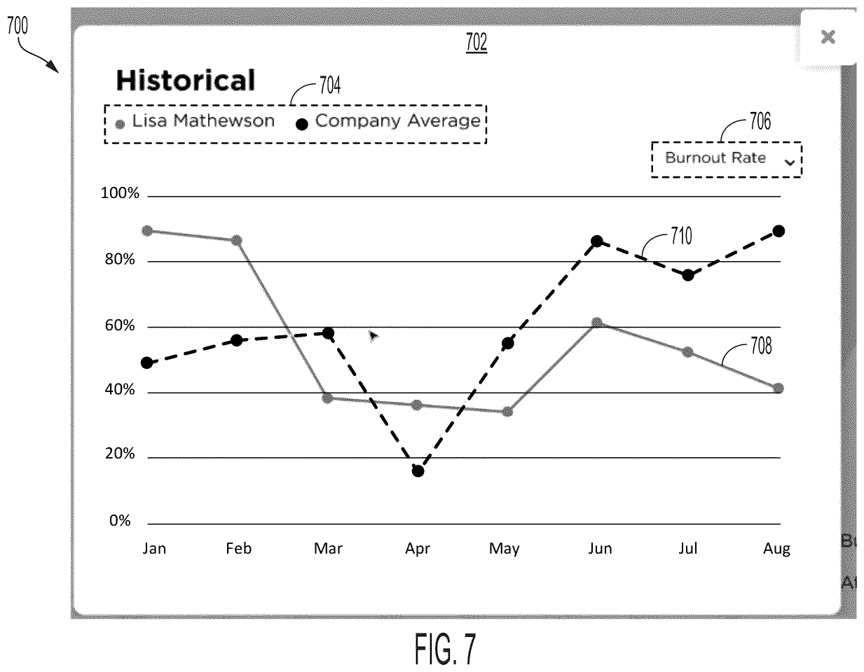

As noted above, the optimization system 110 may aggregate the quantitative partial results provided by the communications system 104, workforce event system 106, and the personal time-off system 108 to determine the level of organizational exhaustion for each employee within an organization. The optimization system 110 may use a normalization table to assign a qualitative descriptor to the aggregated quantitative result corresponding to each employee's level of organizational exhaustion. In an embodiment, the optimization system 110 may provide these quantitative results and corresponding qualitative descriptors corresponding to employee levels of organizational exhaustion to the user 112. For example, if the user 112, through the platform provided by the workforce optimization service 102, submits a request to the optimization system 110 to obtain any scores or metrics corresponding to the level of organizational exhaustion for a particular group of employees and for a particular time range, the optimization system 110 may query the cache storing thereon the collected quantitative results and corresponding qualitative descriptors corresponding to employee levels of organizational exhaustion over time to obtain the requested scores or metrics over the specified period of time. These requested scores or metrics may be presented to the user 112 through one or more interfaces, as described in greater herein in connection with FIGS. 6A-6C and 7.

In an embodiment, the optimization system 110 further allows the user 112, through the platform provided by the workforce optimization service 102, to compare the scores or metrics corresponding to the level of organizational exhaustion for a particular group of employees to the levels of organization exhaustion for different groups of employees and/or organizations associated with the workforce optimization service 102. For instance, through an interface (e.g., a graphical user interface (GUI), etc.), the optimization system 110 may provide the user 112 with options to compare the level of organization exhaustion for a selected group of employees to the level(s) of organization exhaustion for any number of different groups of employees associated with the user's organization and of different organizations. As an illustrative example, if the user's organization is associated with the airline industry, the user 112, through the optimization system 110, may compare the level of organization for a particular group of employees within their organization to other similar groups of employees within other organizations associated with the airline industry that are also affiliated with the workforce optimization service 102. In some instances, the optimization system 110 may allow the user 112 to compare the level of organizational exhaustion for a particular group of employees to levels of organizational exhaustion associated with organizations that are not within the user's industry. Returning to the above example where the user's organization is associated with the airline industry, the user 112, through the optimization system 110, may compare the level of organization for a particular group of employees within their organization to other groups of employees associated with organizations in the legal industry. This may allow the user 112 to perform dynamic benchmarking analyses across different employee groups, organizations, and industries.

In an embodiment, the scores or metrics corresponding to the level of organizational exhaustion for a particular group of employees or for the organization as a whole can be provided to third-party entities associated with the user 112 and/or the workforce optimization service 102. For instance, the workforce optimization service 102 may anonymize the data corresponding to the level of organizational exhaustion within the organization and/or particular groups of employees within the organization to provide industry benchmarks of organizational exhaustion across one or more industries. As an illustrative example, an insurance provider may request, from the workforce optimization service 102, anonymized data corresponding to the level of organizational exhaustion associated with a set of organizations to determine possible insurance risks associated with employees within this set of organizations. Using this anonymized data, the insurance provider may define one or more policies that are tailored according to the potential health risks resulting from the level of organizational exhaustion within the industry.

In some examples, the user 112 can authorize, through the workforce optimization service 102, one or more third-party entities to access the scores or metrics corresponding to the level of organizational exhaustion within the user's organization and/or group of employees. For instance, the user 112 may authorize a consulting firm to access the scores or metrics corresponding to the level of organizational exhaustion for a particular group of employees or for the user's organization to allow the consulting firm to identify any possible avenues for reducing the level of organizational exhaustion within the particular group of employees or for the user's organization. Further, this may allow the consulting firm to identify any other issues that may be affecting the particular group of employees or for the user's organization and resulting in an increase in the level of organizational exhaustion.

It should be noted that the use of quantitative partial results from the communications system 104, the workforce event system 106, and the personal time-off system 108 are used extensively throughout the present disclosure for the purpose of illustration, the determination of the level of organizational exhaustion for each employee within an organization does not require quantitative partial results from each of these systems. For instance, the optimization system 110 may be implemented without requiring quantitative partial results from the communications system 104 and/or the workforce event system 106 should data corresponding to employee communications and/or workforce events (respectively) not be available to the workforce optimization service 102. As an illustrative example, if the communications system 104 does not have access to employee communications associated with a particular organization (e.g., any communications systems implemented by the organization to facilitate employee communications, any communications systems external to the organization but otherwise available to employees (e.g., social media platforms, personal electronic mail, external instant messaging platforms, etc.), etc.), the optimization system 110 may normalize the quantitative partial results associated with the workforce event system 106 and the personal time-off system 108 such that a normalized quantitative result corresponding to each employee's level of organizational exhaustion may be determined absent any quantitative partial results corresponding to employee communications. As another illustrative example, if the workforce event system 106 does not have access to one or more employer systems through which data corresponding to different workforce events can be obtained, the optimization system 110 may normalize the quantitative partial results associated with the communications system 104 and the personal time-off system 108 such that a normalized quantitative result corresponding to each employee's level of organizational exhaustion may be determined absent any quantitative partial results corresponding to workforce events associated with the different employees within an organization. This normalization of available quantitative partial results may allow the optimization system 110 to compare the quantitative level of organizational exhaustion across different organizations regardless of the amount of data that is available from each of these organizations.

In an embodiment, the optimization system 110 can provide one or more recommendations for addressing elevated levels of organizational exhaustion amongst employees within an organization. For example, if a particular manager within the organization consistently refuses to grant their employees' requests for personal time-off and the organizational exhaustion amongst these employees has been increasing over time as a result, the optimization system 110 may generate a recommendation for the manager to be provided with remedial training or with instructions to improve their rate of granting personal time-off requests. Further, if there are any employees within the manager's purview that are particularly experiencing elevated levels of organizational exhaustion as a result of other factors in addition to the continued rejection of personal time-off requests, the optimization system 110 may generate a recommendation for these particular employees to be granted their personal time-off requests immediately in order to address their elevated levels of organizational exhaustion. Further, the recommendation may provide various instructions or steps for addressing these other factors. For example, if an employee's level of organizational exhaustion is elevated as a result of a traumatic event, the optimization system 110, through the recommendation, may suggest providing additional support (e.g., counseling, communications providing condolences, etc.) in order to demonstrate employee value to the organization.

In an embodiment, the optimization system 110 can further use an employee's level of organizational exhaustion as input to a machine learning algorithm or artificial intelligence to provide recommendations to the employee for usage of their personal time-off benefits to reduce their level of organizational exhaustion. For example, the optimization system 110 may use the employee's level of organizational exhaustion in conjunction with the employee's personal time-off benefit usage information and other employee performance information (e.g., overtime hours worked, workers' compensation claims received, etc.) to determine the effect of employee usage of their personal time-off benefits in reducing their level of organizational exhaustion. For example, the PTO conversion service may execute one or more clustering algorithms, such as K-means clustering, means-shift clustering, DBSCAN clustering, EM Clustering using GMM, and other suitable machine-learning algorithms, on datasets comprising levels of organizational exhaustion for employees of the organization over a period of time, personal time-off benefit usage for an organization over the period of time, and employee performance information for employees of the organization over the period of time. In some implementations, a recurrent neural network (RNN) or a convolutional neural network (CNN) may be used to predict correlations between employee usage of personal time-off benefits within an organization and employee levels of organizational exhaustion within the organization. In some implementations, the optimization system 110 may use support vector machines (SVM), supervised, semi-supervised, ensemble techniques, or unsupervised machine-learning techniques to evaluate previous usage of personal time-off benefits within an organization and employee levels of organizational exhaustion within the organization to predict the effect of using personal time-off benefits within the organization towards reducing corresponding levels of organizational exhaustion.

In an illustrative example, the optimization system 110 may evaluate an employee's level of organizational exhaustion, the employee's personal time-off benefits usage, and the employee's performance within their organization. The optimization system 110 may compare the results of this evaluation to the one or more clusters of datasets corresponding to combinations of employee levels of organizational exhaustion, historical usage of personal time-off benefits, and employee performance. These clusters may correspond to an identified impact of personal time-off benefit usage in reducing employee levels of organizational exhaustion over time. For example, a particular cluster may denote a negative impact to employee levels of organizational exhaustion due to excessive use of personal time-off benefits over a period of time. As another example, a particular cluster may denote a negative impact to employee levels of organizational exhaustion as a result of a lack of personal time-off benefit usage within an organization. As yet another example, a particular cluster may denote a positive impact to employee levels of organizational exhaustion as a result of employees being able to use personal time-off benefits for sick leave and vacation.

Once a cluster has been identified, the optimization system 110 may identify the most relevant impact (e.g., positive, negative, or neutral) of personal time-off benefit usage for an employee in reducing their level of organizational exhaustion based on a confidence threshold. As a non-limiting example, a confidence algorithm can be executed to generate a confidence score. A confidence score may be a percentage value where the lower the percentage, the less likely the identified impact of personal time-off benefit usage towards reducing a corresponding level of organizational exhaustion is a good correlation for the employee, and the higher the percentage, the more likely the identified impact is a good correlation for the employee. A minimum confidence threshold may be defined as a measure of certainty or trustworthiness associated with each discovered pattern. Further, as an example of a confidence algorithm may be the Apriori Algorithm, similarity algorithms indicating similarity between two data sets, and other suitable confidence algorithms.

In an embodiment, if the optimization system 110 determines that an employee may be able to reduce their level of organizational exhaustion through usage of their personal-time off benefits, the optimization system 110 can automatically transmit a notification to the employee to indicate that the employee may reduce their level of organizational exhaustion through use of their personal time-off benefits. For example, the optimization system 110 may provide a recommendation to an employee experiencing a significant level of organizational exhaustion to use their personal time-off benefits for a vacation. In addition to the recommendation, the optimization system 110 may provide an indication of an expected reduction to the employee's level of organizational exhaustion should the employee use their personal time-off benefits for the recommended vacation.

In some instances, the optimization system 110 may provide an employer with any insights obtained via evaluation of employee levels of organizational exhaustion and corresponding personal time-off benefits available to employees associated with the employer for reducing these employee levels of organizational exhaustion. For instance, the optimization system 110 may indicate that a particular organization is experiencing significant levels of organizational exhaustion as a result of employees within this organization failing to take advantage of their personal time-off benefits. Accordingly, the optimization system 110 may provide a recommendation to the employer to encourage employees within this organization to take advantage of their personal time-off benefits, subject to any organizational requirements and/or schedules (e.g., upcoming deadlines, upcoming product releases, expected periods of heightened demand, etc.). In some examples, the optimization system 110 may indicate, to an employer, that a particular organization is experiencing increased efficiency, with reduced levels of organizational exhaustion, as a result of employees within this particular organization being able to use their personal time-off benefits to reduce their levels of organizational exhaustion. These insights may guide the employer in determining what steps may be required to balance employee usage of personal time-off benefits, workplace efficiency, and organizational exhaustion.

In an embodiment, to provide the employer with insights related to employee levels of organizational exhaustion, the optimization system 110 implements a machine learning algorithm or artificial intelligence that is trained to generate recommendations for addressing organizational exhaustion associated with an employee and/or groups of employees. The machine learning algorithm or artificial intelligence may be trained using supervised, unsupervised, reinforcement, or other such training techniques. For instance, the machine learning algorithm or artificial intelligence may be trained using a dataset comprising sample initial employee organizational exhaustion scores, actions performed to address employee organizational exhaustion, and revised organizational exhaustion scores. This dataset may be analyzed using the machine learning algorithm or artificial intelligence to identify correlations between different elements of the dataset without supervision and feedback.

As an example of a supervised training technique, a dataset can be selected for training of the machine learning algorithm or artificial intelligence to facilitate identification of correlations between organizational exhaustion amongst different groups of employees, actions performed to address this organizational exhaustion, and the impact such actions had on the organizational exhaustion amongst these different groups of employees. The machine learning algorithm or artificial intelligence may be evaluated to determine, based on the sample inputs supplied to the machine learning algorithm or artificial intelligence, whether the machine learning algorithm or artificial intelligence is producing accurate correlations between members of the dataset (e.g., given a level of organizational exhaustion for a particular employee or group of employees, the machine learning algorithm or artificial intelligence is accurately identifying the appropriate one or more actions for reducing the level of organizational exhaustion). As an illustrative example of the training of the machine learning algorithm or artificial intelligence, an evaluator of the machine learning algorithm or artificial intelligence may review the actions or recommendations identified by the machine learning algorithm or artificial intelligence to determine whether these actions or recommendations correspond to the level of organizational exhaustion for the employee or group of employees and characteristics of the employee or group of employees (e.g., any known events impacting their organizational exhaustion, rejection of personal time-off requests, extended periods without breaks or with overtime, etc.). To determine whether these actions or recommendations are appropriate, the evaluator may evaluate feedback corresponding to these actions or recommendations. This feedback may include later levels of organizational exhaustion associated with the selected employee or group of employees. The later levels of organizational exhaustion may indicate whether the actions or recommendations, if adhered to, led to a reduction or improvement in the levels of organizational exhaustion for the employee or group of employees. The evaluator, using these later levels of organizational exhaustion, may determine whether the actions or recommendations provided are appropriate or otherwise consistent for addressing the original levels of organizational exhaustion and associated root causes. Accordingly, based on this evaluation, the evaluator may re-train and/or improve the machine learning algorithm or artificial intelligence to improve the likelihood of the machine learning algorithm or artificial intelligence identifying appropriate actions or recommendations according to the levels of organizational exhaustion for an employee or groups of employees.

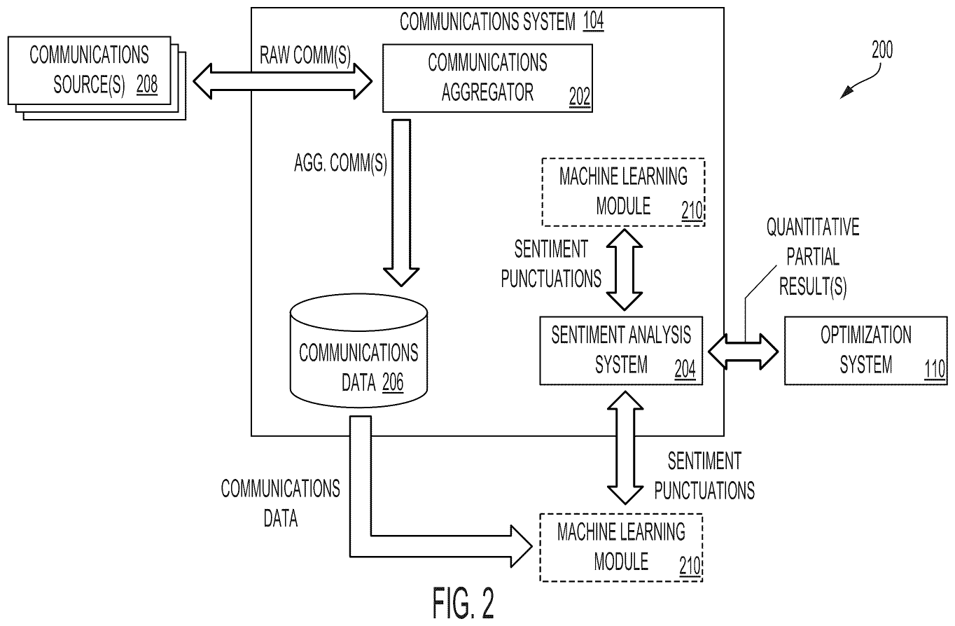

FIG. 2 shows an illustrative example of an environment 200 in which a communications system 104 associated with a workforce optimization service processes, in real-time, employee communications from various sources 208 to determine corresponding sentiments used to provide indications of organizational exhaustion in accordance with at least one embodiment. In the environment 200, the communications system 104 may implement a communications aggregator 202 that may automatically, and in real-time, aggregate raw communications from one or more communications sources 208. The communications aggregator 202 may be implemented on a computing system or other system (e.g., server, virtual machine instance, etc.) associated with the communications system 104. In some instances, the communications aggregator 202 may be implemented as an application or other executable code that is executed on a computing system or other system associated with the communications system 104.

In an embodiment, the communications aggregator 202 obtains, in real-time, raw communications data from one or more communications sources 208. The raw communications data may include communications exchanged through electronic mail servers, chat sessions, voice conversations (e.g., telephonic and/or VoIP), and the like. The one or more communications sources 208 may include any communications systems and/or services that may be operated by an employer or other organization that maintains a workforce. Additionally, the one or more communications sources 208 may include any third-party communications systems and/or services that may not be associated with the employer or other organization but that otherwise may provide employees associated with the employer or other organization with one or more communications channels for communicating with other employees and/or other entities that may not be associated with the employer or other organization (e.g., friends, family members, etc.). In some instances, if the communications sources 208 include third-party communications systems and/or services through which employees exchange communications with other entities not associated with the employer or other organization, the communications system 104 may prompt these employees to provide permission or otherwise authorize the communications aggregator 202 to monitor these communications in real-time in order to obtain additional data that may be used to determine organizational exhaustion amongst these employees.

As the communications aggregator 202 monitors, in real-time, communications exchanged amongst employees associated with the employer or other organization and communications exchanged between employees and other entities not associated with the employer or other organization, the communications aggregator 202 may annotate these communications according to the entities involved. For example, if a particular employee is engaged in a chat session with a family member, the communications aggregator 202 may generate a new entry within a communications datastore 206, where this entry may correspond to this chat session and to the employee. The new entry may be assigned a unique identifier, which may correspond to both the particular communications session the employee is engaged in and the employee. Thus, a query for any communications session associated with the employee may return this particular communications session and any other communications sessions that the employee may be engaged in.

In an embodiment, the communications system 104, through a machine learning module 210, processes communications exchanged amongst employees associated with the employer or other organization and any communications between employees and third-party entities not associated with the employer or other organization to determine employee sentiments for each of these communications. The machine learning module 210, in some instances, may be implemented on a computing system or other system (e.g., server, virtual machine instance, etc.) associated with the communications system 104. In some instances, the machine learning module 210 may be implemented as an application or other executable code that is executed on a computing system or other system associated with the communications system 104. Alternatively, the machine learning module 210 may be implemented by one or more third-party service providers, through which the communications system 104 may, in real-time, maintain a data stream or feed through which communications data associated with real-time communications and stored in the communications datastore 206 is provided to the machine learning module 210 for extracting sentiments from these real-time communications.

The machine learning module 210, in an embodiment, implements a machine learning algorithm or artificial intelligence that is dynamically trained to perform a semantic analysis of communications data from the communications datastore 206. As noted above, this communications data may correspond to communications exchanged via the one or more communications channels provided by the one or more communications sources 208 and associated with the workforce or organization and/or the one or more communications channels that are not associated with the workforce or organization (subject to employee approval). The machine learning algorithm or artificial intelligence implemented by the machine learning module 210 may be dynamically trained to identify, from communications exchanged through different communications channels, keywords, sentence structures, repeated words, punctuation characters and/or non-article words and the like in order to identify employee sentiments expressed through these communications.

As noted above, the machine learning algorithm or artificial intelligence used to determine employee sentiment from communications exchanged between the employee and other employees or other entities not associated with the employer or organization may be trained using supervised learning techniques. The machine learning module 210, in an example, may select a dataset of input communications and known sentiments expressed in the input communications for training of the machine learning algorithm or artificial intelligence. The machine learning algorithm or artificial intelligence may be evaluated to determine, based on the input sample communications supplied to the machine learning algorithm or artificial intelligence, whether the machine learning algorithm or artificial intelligence is extracting the expected sentiments from each of these communications. Based on this evaluation, the machine learning algorithm or artificial intelligence may be modified or re-trained to increase the likelihood of the machine learning algorithm or artificial intelligence generating the desired results. The machine learning algorithm or artificial intelligence may further be dynamically trained by soliciting feedback from users with regard to the extracted sentiments obtained from exchanged communications.

As the communications data may include textual and audial communications exchanged amongst employees and other entities, the machine learning module 210 may implement the machine learning algorithm or artificial intelligence using NLP, which can process both textual and audial communications to identify the keywords, sentence structures, repeated words, punctuation characters and/or non-article words and the like expressed within each communication in real-time. In an embodiment, using NLP and for each communication obtained from the communications datastore 206, the machine learning module 210 assigns a confidence score for each possible sentiment that may be expressed within a communication. These confidence scores may be used as a weight or factor that may be applied to the particular sentiment used to determine the quantitative partial result corresponding to the employee's level of organizational exhaustion. Additionally, for a particular sentiment, the machine learning module 210, through the machine learning algorithm or artificial intelligence, may dynamically determine the magnitude of the particular sentiment within a communication. The magnitude, along with the confidence score, for the particular sentiment may be used to assign a quantitative partial result for the communication, as described in greater detail herein.

In an embodiment, the machine learning module 210 can measure, in real-time, employee behavior from the exchanged communications retrieved from the communications datastore 206 according to detected sentiments. For example, the machine learning module 210 may identify, in real-time using the machine learning algorithm or artificial intelligence, any communications that may be indicative of the quality and quantity of tools that an employee may use to perform assigned tasks, as employees may routinely express various sentiments related to the quality and quantity of these tools. For instance, an employee that is provided with inferior or ineffective tools may experience a degradation in their performance and, thus, increase their organizational exhaustion. If an employee expresses, through a communication, that they are frustrated with the tools provided for performance of their duties, the machine learning module 210, through the machine learning algorithm or artificial intelligence, may assign a negative polarity (e.g., score or other metric) to this communication.

Additionally, the machine learning module 210 may process communications exchanged amongst employees associated with a particular role to determine a sentiment for each of these employees and a corresponding score or other metric for the sentiment. As various employees may have a similar role within an organization, sentiments associated with this role may be used to determine a baseline sentiment amongst these employees for the particular role. The machine learning module 210, thus, may identify any deviations from the baseline sentiment amongst employees having the particular role, as these deviations may be indicative of a change in an employee's organizational exhaustion. In some instances, the machine learning module 210 may alternatively provide a score or other metric for the sentiment expressed by an employee associated with a particular role. As scores or other metrics are determined, the communications system 104, through a sentiment analysis system 204, may aggregate these scores or other metrics in order to identify the average sentiment score or other metric for the particular role. For each employee associated with the particular role, the sentiment analysis system 204 may consider any statistical deviation from the average sentiment score or metric as this may be indicative of a change in sentiment for the employee and, thus, may be indicative of a change in the employee's organizational exhaustion. The sentiment analysis system 204 may be implemented on a computing system or other system (e.g., server, virtual machine instance, etc.) associated with the communications system 104. In some instances, the sentiment analysis system 204 may be implemented as an application or other executable code that is executed on a computing system or other system associated with the communications system 104.

The machine learning module 210, through the machine learning algorithm or artificial intelligence, may further process communications from the communications datastore 206, to identify any public recognition associated with an employee. The machine learning algorithm or artificial intelligence may measure the sentimental state from these communications, as the sentimental effect of public recognition may, in some instances, reduce the organizational exhaustion of an employee. However, this measurement of the employee's sentiment based on public recognition may be tailored such that, over time, the impact to the employee's organizational exhaustion is decreased. In some instances, to ensure that this measurement decreases over time, the sentiment analysis system 204 may dynamically apply a weighting factor that is automatically reduced based on the amount of time that has elapsed since the public recognition was given to the employee.

As noted above, the communications aggregator 202 can monitor, in real-time, communications exchanged by an employee with other employees (such as through communications sources associated with an employer or other organization) and with other entities that may not be associated with an employer or organization (such as through communications sources not associated with the employer or other organization). Through these communications channels, the machine learning module 210 may process any communications corresponding to any personal events associated with an employee to determine the sentimental impact to the employee's organizational exhaustion. Through the machine learning algorithm or artificial intelligence implemented by the machine learning module 210, the machine learning module 210 may measure the quantity of communications initiated by colleagues and/or by the organization corresponding to recognition of an employee's personal event. As another illustrative example, if the employee has suffered a personal tragedy, the machine learning module 210, through the machine learning algorithm or artificial intelligence, may measure the quantity of communications initiated by colleagues and/or by the organization providing their condolences.

The machine learning module 210 may further process the communications from the communications datastore 206 to determine each employee's level of interaction with their colleagues and, based on these communications, determine the employee's sentiment. For instance, the machine learning module 210, through the machine learning algorithm or artificial intelligence, may measure the sentimental state from any interaction (through any available communications channel) with the employee's colleagues or other entities associated with an organization. This measurement, which may be provided in the form of a score or other metric corresponding to the employee's sentimental state, may be processed by the sentiment analysis system 204, whereby the sentiment analysis system 204 may scale this score or metric according to the volume of communications between the employee and their colleagues or other entities, as well as according to the number of entities involved in each communication.

The machine learning module 210, through the machine learning algorithm or artificial intelligence, may also process communications from the communications datastore 206 to detect any communications that may be indicative of an employee's desire to depart from the organization or that are otherwise indicative of their sentiment with regard to the organization. For instance, if an employee expresses frustration at being unable to go on vacation as a result of a major assignment, the machine learning algorithm or artificial intelligence may assign a negative polarity to such a communication and, thus, assign a negative score or metric for the employee's particular sentiment. A similar negative polarity may be assigned to communications where the employee is denied a request to use their personal time-off benefits for a special event or other event that the employee has ascribed a high importance to.

The machine learning module 210 may transmit the resulting scores or metrics corresponding to employee sentiments expressed in the real-time communications obtained from the communications datastore 206 in the form of an array of sentiment punctuations. The sentiment analysis system 204, in an embodiment, aggregates the array of sentiment punctuations corresponding to employee sentiments expressed in the exchanged communications over a particular period of time to determine an average sentiment score or metric that may be used to determine each employee's organizational exhaustion over this particular period of time. By determining an average sentiment score or metric that may be used to determine each employee's organizational exhaustion over this particular period of time, the sentiment analysis system 204 may normalize each employee's sentiment over the particular period of time and obtain quantitative partial results corresponding to the contribution that each employee's sentiment has on their organizational exhaustion.

As noted above, the normalized sentiment score or metric for an employee may be adjusted according to a factor or weight determined based on the contribution of the employee's sentiment to the overall organizational exhaustion for the employee. For example, if employee sentiment accounts for 30% of an employee's organizational exhaustion, the sentiment analysis system 204 may apply a factor or weight to the normalized sentiment score or metric such that the resulting quantitative partial result corresponding to an employee's sentiment is within a range of −30% to 30% of the possible organizational exhaustion for the employee. The resulting quantitative partial result may be negative, as a positive employee sentiment may provide a positive impact against organizational exhaustion, thereby reducing the employee's overall organizational exhaustion score or metric. The sentiment analysis system 204 may provide these quantitative partial results to the optimization system 110, which may aggregate these quantitative partial results with other quantitative partial results corresponding to workforce events and requested personal time-off data in order to generate the quantitative values used to determine an amount of organizational exhaustion for the workforce or organization and for each employee associated with the workforce or organization.

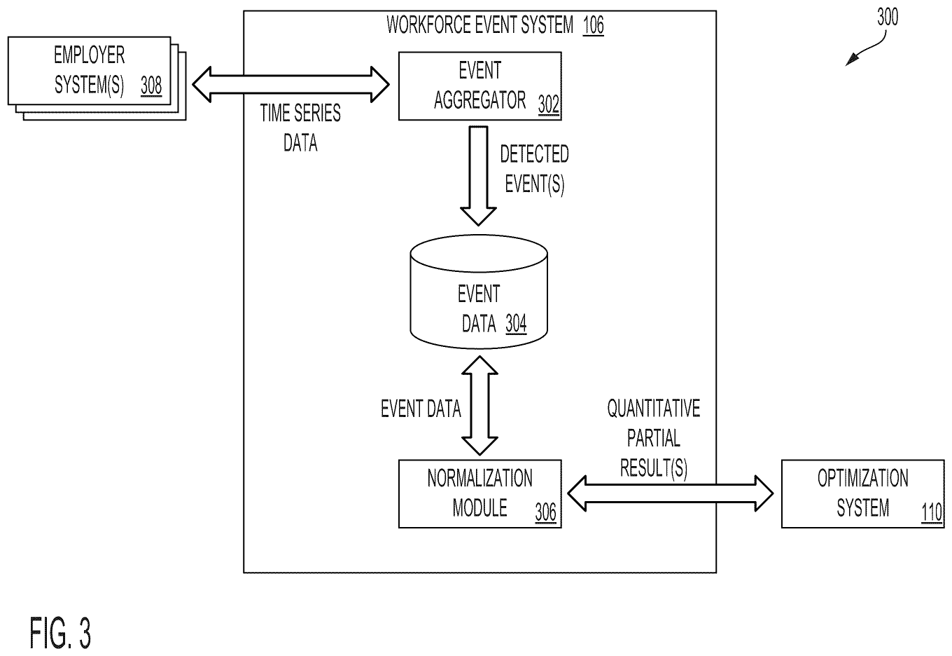

FIG. 3 shows an illustrative example of an environment 300 in which a workforce event system 106 associated with a workforce optimization service processes real-time time series data to identify events associated with a set of employees to identify any indications of organizational exhaustion in accordance with at least one embodiment. In the environment 300, the workforce event system 106 may implement an event aggregator 302 that may automatically, and in real-time, aggregate time series data from one or more employer systems 308. The event aggregator 302 may be implemented on a computing system or other system (e.g., server, virtual machine instance, etc.) associated with the workforce event system 106. In some instances, the event aggregator 302 may be implemented as an application or other executable code that is executed on a computing system or other system associated with the workforce event system 106.

In an embodiment, the event aggregator 302 obtains, in real-time, time series data from one or more employer systems 308. The time series data may correspond to employee events occurring within the organization that may have an impact on an employee's organizational exhaustion. For instance, the time series data may include data corresponding to the time elapsed between clock-in and clock-out events for an employee over a particular period of time (e.g., weekly, monthly, etc.). This time series data may further include any periods of rest between clock-in and clock-out events, whereby an employee may enjoy a break period during workdays, not including any usage of personal time-off benefits. In some instances, the event aggregator 302 may compare the time series data to known employee work schedules such that the event aggregator 302 may automatically, and in real-time, determine when an employee is working beyond their defined work schedule and/or has continued to work without a break period.

The one or more employer systems 308 may include employer payroll systems, shift management and staff scheduling systems, employer timekeeping and attendance systems, employer ticketing and support systems, project management and/or “To-Do” systems, employer calendaring systems, HRS (e.g., HRIS, HRMSs, HCMSs, etc.), an HRS provider utilized by an employer, and the like. In an embodiment, the one or more employer systems 308 can further include employer payroll systems, employer timekeeping systems, HRS, and HRS providers associated with different employers. In some instances, the one or more employer systems 308 may further include one or more communications sources, such as any of the communications sources 208 described above in connection with FIG. 2. In an embodiment, the event aggregator 302 can cross-reference the time series data with organization and employee calendars to determine if an employee is working on holidays, during blackout periods, during a schedule vacation or other personal time-off period, or otherwise outside of their regular or formal schedule. For instance, the event aggregator 302 may automatically process any employee communications (in conjunction with the communications system or independently) to identify any communications that are indicative of an employee performing any tasks outside of their regular/formal schedule or during a scheduled time off. In an embodiment, the event aggregator 302 can implement a machine learning algorithm or artificial intelligence using NLP to identify the keywords, sentence structures, repeated words, punctuation characters and/or non-article words and the like expressed within each communication in real-time to detect when an employee is performing any tasks outside of their regular/formal schedule or during a scheduled time off.

In an embodiment, the event aggregator 302 further obtains data, in real-time, from one or more external systems that may not be associated with a particular employer. For instance, the event aggregator 302 may obtain data from a weather service to determine whether any weather events are imminent that may have an impact on employee organizational exhaustion within geographic regions where these weather events are to occur. As an illustrative example, if the event aggregator 302 obtains weather-related data indicative of an impending hurricane that may impact a geographic region associated with a particular employer organization, the event aggregator 302 may detect an event (e.g., impending hurricane) that may negatively impact the organizational exhaustion for employees within the geographic region.

In addition to weather-related data, the event aggregator 302 may obtain data from one or more external news services, through which the event aggregator 302 may detect any newsworthy events that may have an impact on employee organizational exhaustion. As an illustrative example, if the event aggregator 302 detects that a tumultuous election is imminent (e.g., within the next month, within the next week, etc.) within a particular geographic region associated with the employer, the event aggregator 302 may record this tumultuous election as an event that may impact the organizational exhaustion of employees within this particular geographic region. As another illustrative example, if the event aggregator 302 detects, from these one or more external news services, other socioeconomic issues that may impact employee organizational exhaustion (e.g., fluctuations in crime rates, fluctuations in unemployment or jobless claims, economic inflation, supply shortages, etc.), the event aggregator 302 may further record these socioeconomic issues as events that may impact the organizational exhaustion of employees within the impacted geographic regions associated with the employer. Other possible external sources of data may include government (local and/or national) agencies, financial institutions, census data, and the like.

If the event aggregator 302 implements a machine learning algorithm or artificial intelligence to detect when an employee is performing any tasks outside of their regular/formal schedule or during a scheduled time off, the event aggregator 302 may dynamically train the machine learning algorithm or artificial intelligence to perform a semantic analysis of exchanged communications to identify any indications of an employee performing tasks outside of their regular/formal schedule or during a scheduled time off. The machine learning algorithm or artificial intelligence utilized by the event aggregator 302 may be dynamically trained using supervised learning techniques. For instance, a dataset of input communications, employee schedules, and known indicators of task performance expressed in these input communications can be selected for training of the machine learning algorithm or artificial intelligence. The machine learning algorithm or artificial intelligence may be evaluated to determine, based on the input sample communications and employee schedules supplied to the machine learning algorithm or artificial intelligence, whether the machine learning algorithm or artificial intelligence is accurately identifying when an employee is performing a work-related task outside of their known schedule or during a scheduled time off. Based on this evaluation, the machine learning algorithm or artificial intelligence may be modified to increase the likelihood of the machine learning algorithm or artificial intelligence generating the desired results. The machine learning model may further be dynamically trained by soliciting feedback from users with regard to the determinations made from submitted communications and corresponding schedules.

The time series data may further indicate any changes to the workforce over a particular period of time. The event aggregator 302 may, thus, compare this time series data to the required number of active employees for the workforce associated with each employee (e.g., product team, internal organization, business unit, etc.). Through this comparison, the event aggregator 302 may detect any discrepancies between the number of current, active employees within the workforce and the required number of active employees. Further, the event aggregator 302 may measure the quantity of activities per employee while taking into consideration the employee's role within the organization. For instance, the event aggregator 302 may measure the number and complexity of these activities over a period of time given the employee's assigned role. For example, if the employee has been assigned a significant number of complex tasks that are not usually within the ambit of the employee's responsibilities, this may serve as an indication that the employee is more likely to experience organizational exhaustion over this period of time.

Through the time series data, the event aggregator 302 may further identify any deviations in employee salaries compared to peers within the organization and to peers employed by other similarly-situated organizations (e.g., other companies, etc.). For example, the event aggregator 302, for a particular employee, may measure the employee's wage based on their role and against wages associated with their colleagues within the organization and other similarly-situated organizations (e.g., other companies having similar employee roles, etc.). Any deviations in wages may be evaluated according to the employee's appreciation of their present wage, whereby employee sentiment (as determined through the communications system) may be used as a factor or weight in adjusting any score or metric associated with such wage deviations. In some instances, the event aggregator 302 may automatically process any employee communications (in conjunction with the communications system or independently) to identify any communications that are indicative of an employee's sentiment with regard to their present wage or salary. This sentiment may be used as a separate factor in determining a metric or score corresponding to contribution of the employee's wage to their organizational exhaustion.

Similarly, the event aggregator 302 may further use the time series data to determine whether an employee has received a salary increase over a particular period of time. For instance, the workforce event system 106 may compare an employee's wage during a previous period of time (e.g., previous month, etc.) to the employee's present wage to identify any increases in the employee's wage. If an increase is detected, the workforce event system 106 may assign a score that is tailored such that, over time, the impact to the employee's organizational exhaustion is decreased. In some instances, to ensure that this score decreases over time, the workforce event system 106 may dynamically apply a weighting factor that is automatically reduced based on the amount of time that has elapsed since the change to the employee's wage.

The event aggregator 302 may further evaluate the time series data from the one or more employer systems 308 to measure the elapsed time between the start of employee activities or tasks and the end or change in status of these employee activities or tasks in order to identify any employee delays in the performance of these activities or tasks. The event aggregator 302 may compare the elapsed time in performance of an activity or task to the expected amount of time required for performance of the activity or task. The expected amount of time may be determined based on schedules or calendars maintained by the organization (e.g., Gantt charts, project schedules, scrum boards, Kanban boards, etc.). In some instances, the event aggregator 302 may use a machine learning algorithm or artificial intelligence to determine an estimated amount of time for completion of an activity or task. For example, the workforce event system 106 may execute one or more clustering algorithms on datasets comprising previously performed activities or tasks in order to generate clusters corresponding to different activity or task types. Based on a set of characteristics of the particular activity or task, the event aggregator 302 may identify a particular cluster of similar activities or tasks, from which the event aggregator 302 may automatically determine an estimated amount of time for completion of the activity or task. Based on any identified deviations between the elapsed time for performance of an activity or task and the expected time required for completion of the activity or task, the event aggregator 302 may assign a score or measurement that may correspond to an amount of organizational exhaustion resulting from delays in performance of the activity or task. As noted above, this score or measurement may be dynamically adjusted based on one or more factors including, but not limited to, the complexity or difficulty of the activity or task.

The event aggregator 302 may further identify, from the time series data and/or from other data obtained from the one or more employer systems, the quantity of errors and rollbacks associated with activities or tasks resulting from failure to satisfy established criteria for performance of these activities or tasks. Based on the quantity of errors and rollbacks associated with these activities or tasks, the event aggregator 302 may determine a rate of errors and rollbacks over a period of time. A higher rate of error may correspond with a higher level of organizational exhaustion and, thus, may be assigned a higher score that may be used to determine the overall organizational exhaustion for employees associated with these activities or tasks.

In some instances, the event aggregator 302 may further identify, from the time series data and/or from other data obtained from the one or more employer systems, the number of job titles and number of direct reports (e.g., supervisors, managers, etc.) associated with each employee within the organizations being evaluated. For instance, as the number of job titles increases for an employee, the organizational exhaustion associated with this employee may increase as the number of job titles may be correlated with the number of tasks and responsibilities assigned to the particular employee at any given time. Further, as the number of job titles increases, there is a higher likelihood that an employee may be required to perform disparate and unrelated duties across these different job titles, which may have a negative impact on the employee's level of organizational exhaustion. Similarly, there may be a correlation between the number of direct reports and an employee's level of organizational exhaustion. For instance, a greater number of direct reports may be indicative of an employee having to satisfy a greater number of requirements associated with their duties and tasks, as these duties and tasks may be supervised by a greater number of entities that may have different requirements that the employee may be required to satisfy. This greater level of scrutiny may result in a greater level of organizational exhaustion for the employee.

The event aggregator 302 may further identify, from the time series data and/or from other data obtained from the one or more employer systems, the amount of time each employee has been assigned to a particular role and/or has held their current job title. For instance, if a particular employee has held their current job title for a significant period of time, this may be an indicator of a lack of advancement in the particular employee's career. This lack of advancement may result in a greater level of organizational exhaustion for the particular employee, as the particular employee (over time) may become disillusioned with their current role. As another illustrative example, if a particular role is associated with a higher level of stress (e.g., greater responsibilities, greater overtime requirements, greater number of direct reports, etc.), the level of organizational exhaustion for an employee assigned to this particular role may increase at a greater rate over time.

In some instances, demographic information associated with the particular organization being evaluated may be used by the event aggregator 302 to determine their contribution to the level of organizational exhaustion for each employee associated with the particular organization. As an illustrative example, an employee's age may serve as a contributing factor to the employee's level of organizational exhaustion. For instance, an employee that may be nearing retirement age may be more susceptible to organizational exhaustion, as they may experience greater fatigue resulting from overwork, assignment of a greater number of tasks or roles, inability to take advantage of their personal time-off benefits, and the like. Further, if an employee's company or organization has been the subject of age-based discrimination claims in the past, an employee's age may be a contributing factor to their organizational exhaustion as their age may create an apprehension towards the company or organization. In some instances, factors that may lead to greater organizational exhaustion may be generational, whereby employees within certain age groups may be more susceptible to experiencing greater levels of organizational exhaustion compared to their peers in other age groups. For example, millennial and Generation Z employees may be more susceptible to organizational exhaustion resulting from overwork and/or lack of personal time-off when compared to Generation X employees.

Similar to the possible age-based impact to an employee's organizational exhaustion, an employee's gender identity, race, ethnicity, and/or sexual orientation may be factors that may impact the employee's organizational exhaustion. For instance, known issues related to gender-based discrimination and/or discrimination based on an employee's gender identity and/or sexual orientation (e.g., within the company or individual organization, within the community at large, etc.) may have a significant impact on an employee's organizational exhaustion, as concerns related to potential or actual discrimination may impact the employee's morale and/or ability to focus on tasks at hand. Further, known issues related to racial and/or ethnic discrimination may have a significant impact on an employee's organizational exhaustion when the employee is of the race and/or ethnicity that is the target of the discrimination.

In addition to issues related to potential or actual discrimination, the amount of diversity within a company or organization within the company may have an impact on an employee's organizational exhaustion. For instance, if the employee's organization or company at-large does not have a commitment to workplace diversity (e.g., certain minority groups are underrepresented, no initiatives have been established to provide diversity, equity, and inclusion (DEI), etc.), the employee may not feel that they are valued or visible within the organization and the company at-large. Accordingly, this feeling of a lack of value or visibility may result in an increase in the employee's organizational exhaustion. Thus, in addition to evaluating demographic information associated with the particular organization, the event aggregator 302 may further evaluate DEI information associated with the particular organization and with the company at-large to gauge the potential impact DEI initiatives (or lack thereof) may have on employee organizational exhaustion given the demographics of the organization and of the company at-large.

In an embodiment, the event aggregator 302 further evaluates biometric data associated with employees associated with the employer or organization to identify any health-related indicators of organizational exhaustion. For example, employees associated with the employer or organization may be provided with an opportunity to opt-in to provide biometric data, such as through any fitness devices or applications. Biometric data may include heart rate data, blood pressure data, weight data, blood oxygen data, electrocardiogram (ECG) data, exercise data, and the like. If an employee opts in to provide their biometric data to the event aggregator 302, the event aggregator 302 may collect the biometric data from the employee in real-time and as the biometric data is generated through the employee's one or more fitness devices or applications. For instance, the event aggregator 302 may monitor one or more external systems that are implemented to aggregate biometric data for various entities (e.g., systems associated with fitness device or application providers, etc.) to obtain biometric data for these employees. Additionally, or alternatively, the event aggregator 302 may obtain this biometric data directly from the employee's one or more fitness devices or applications.

In an embodiment, the event aggregator 302 implements (such as through the workforce optimization service or through a third-party service) an application programming interface (API) through which the event aggregator 302 can communicate with one or more external systems in real-time to obtain the aforementioned biometric data. For instance, employees (such as through an onboarding process, a process implemented by the workforce optimization service, a process implemented by an employer, etc.) may provide their authorization to the event aggregator 302 to automatically, and in real-time, obtain biometric data associated with these employees. For example, the event aggregator 302 may prompt each employee to provide their authorization for obtaining biometric data from their one or more fitness devices and/or applications. In response to this prompt, a user may provide their authorization and indicate which fitness devices and/or applications are to be monitored in real-time in order to obtain their biometric data. If employee authorization is provided, the event aggregator 302, through the API, may automatically, and in real-time, pull the employee's biometric data from the employee's designated fitness devices and/or applications as this biometric data is generated. In some instances, through the API, the designated fitness devices and/or applications may automatically, and in real-time, push the employee's biometric data to the event aggregator 302 as the biometric data is generated.

In some instances, the event aggregator 302 may leverage any available APIs associated with an employee's fitness devices and/or applications (subject to any applicable permissions or authorization) to obtain the employee's biometric data in real-time as the biometric data is generated. For instance, an employee may provide, as part of their authorization for obtaining biometric data from their fitness devices and/or applications, identifying information associated with these fitness devices and/or applications. Using this identifying information and the corresponding APIs, the event aggregator 302 may establish a real-time communications channel with the one or more fitness devices and/or applications utilized by the employee to obtain their biometric data. In some instances, the employee may be prompted by the workforce optimization service to connect to any accounts associated with their fitness devices and/or applications to provide their authorization to obtain biometric data from these fitness devices and/or applications and to enable use of the corresponding APIs to obtain, in real-time, this biometric data.

Using an employee's biometric data, the event aggregator 302 may automatically detect any fluctuations in the employee's health that may be indicative of a change in the employee's organizational exhaustion. For example, fluctuations in an employee's heart rate, blood pressure, weight, etc. over the course of a period of time that corresponds to a workplace event (e.g., increased overtime, additional responsibilities assigned to the employee, layoffs within the organization and/or company at-large, etc.) or a personal event (e.g., death in the family, birth of a new child, a divorce, a move to a new location, etc.) may be indicative of an increase in the employee's organizational exhaustion over that period of time. In some instances, such fluctuations in the employee's health may be naturally occurring and not the result of any workplace or personal event. However, such fluctuations may indicate an employee's worsening health, which may have an impact on the employee's organizational exhaustion, particularly if such worsening health presents an additional concern for the employee.

In an embodiment, the event aggregator 302 stores data corresponding to the detected events and any calculated scores or metrics corresponding to these events in an event datastore 304. An entry in the event datastore 304 may correspond to a particular detected event, which may correspond to one or more employees associated with the employer or organization. Thus, an entry corresponding to a particular detected event may indicate the involved employees, as well as any timestamps corresponding to when the particular detected event occurred. This information may be used by a normalization module 306 implemented by the workforce event system 106 to aggregate and normalize any employee scores or metrics corresponding to the detected events over a particular period of time (e.g., weekly, monthly, etc.) in order to determine the contribution of these events to the employee's overall organizational exhaustion. The normalization module 306 may be implemented on a computing system or other system (e.g., server, virtual machine instance, etc.) associated with the workforce event system 106. In some instances, the normalization module 306 may be implemented as an application or other executable code that is executed on a computing system or other system associated with the workforce event system 106.

In an embodiment, the normalization module 306 processes the various scores and metrics from the event datastore 304 and corresponding to the measurements described above using linear normalization to generate a quantitative partial result corresponding to the impact these particular workforce events have had on employees' organizational exhaustion over a period of time. For example, if the workforce events described above account for 20% of an employee's organizational exhaustion, the normalization module 306 may apply a factor or weight to each normalized event score or metric such that the resulting quantitative partial result corresponding to events associated with an employee is within a range of 0% to 20% of the possible organizational exhaustion for the employee. The normalization module 306 may provide these quantitative partial results to the optimization system 110, which may aggregate these quantitative partial results with other quantitative partial results corresponding to employee sentiments and requested personal time-off data in order to generate the quantitative values used to determine an amount of organizational exhaustion for the workforce or organization and for each employee associated with the workforce or organization.

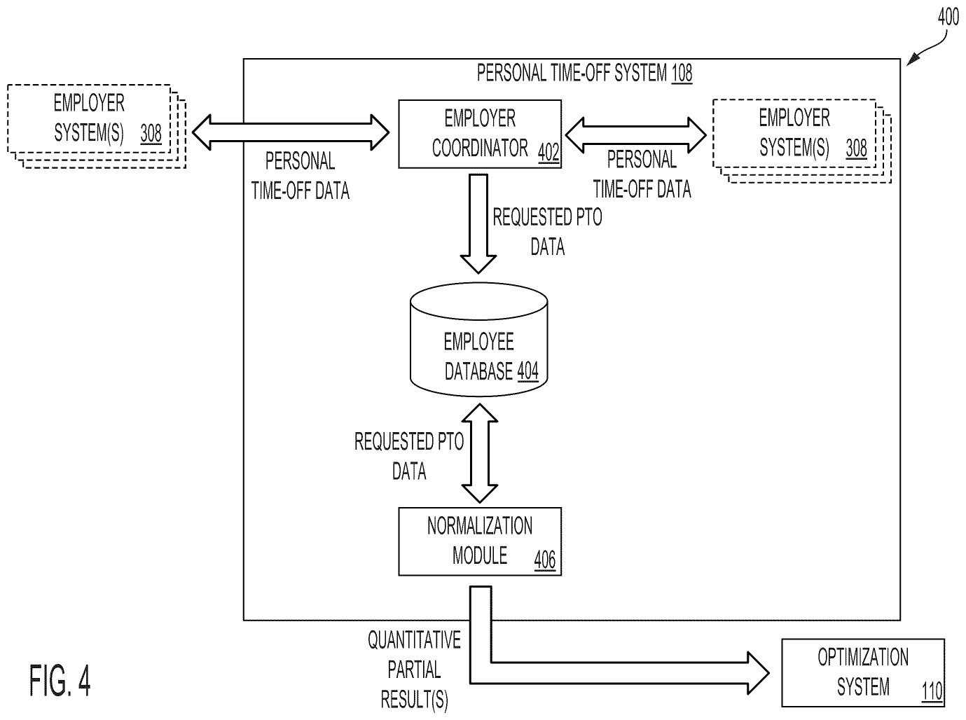

FIG. 4 shows an illustrative example of an environment in which a personal time-off system 108 associated with a workforce optimization service processes personal time-off benefit requests and corresponding responses to identify any indications of organizational exhaustion in accordance with at least one embodiment. In the environment 400, the personal time-off system 108 may implement an employer coordinator system 402 that may automatically, and in real-time, aggregate time series data from one or more employer systems 308. The employer coordinator system 402 may be implemented on a computing system or other system (e.g., server, virtual machine instance, etc.) associated with the personal time-off system 108. In some instances, the employer coordinator system 402 may be implemented as an application or other executable code that is executed on a computing system or other system associated with the personal time-off system 108.

The employer coordinator system 402 may periodically, or in response to a triggering event (e.g., new employee onboarding, employee termination, etc.), obtain employee information from one or more employer systems 308 of an employer. This employee information may include employee identifiers, employee wage information, employee personal time-off balances, and the like. The employer coordinator system 402 may update an employee database 404 using the provided employee information. In some instances, the employer coordinator system 402 may obtain, in real-time, personal time-off data from the one or more employer systems 308 as personal time-off requests from employees are processed.

In an embodiment, the employer coordinator system 402 evaluates the real-time personal time-off data to determine, for each employee associated with an employer or organization, the last time a request to utilize a personal time-off benefit was approved. For instance, the employer coordinator system 402 may identify, from the obtained data, any communications or entries corresponding to employee requests for use of a personal time-off benefit, as well as any administrative approval of any of these employee requests for personal time off from work. This may include approvals for personal time-off associated with vacations, rest days, family leave, and the like. As the amount of time from the previously approved request increases, the employer coordinator system 402 may assign an increasing score or metric that may be indicative of an employee's lack of personal time-off over time. This lack of personal time-off may serve as an indicator of possible fatigue, which may result in greater organizational exhaustion for the employee.

The employer coordinator system 402 may further evaluate the obtained data to identify any unscheduled and/or extra personal time-off provided to an employee over a period of time. For instance, the employer coordinator system 402 may automatically process the obtained data to determine the amount of additional time-off provided to an employee during a particular time period and that may have been provided outside of the traditional amount of personal time-off that is assigned to the employee or that the employee otherwise has accrued over time. This additional time-off may be provided, for example, as a result of a sudden event that requires the employee to be away from their employment. The impact of this additional time-off to an employee's organizational exhaustion may be determined based on any communications exchanged by the employee with others within the organization and other entities, such as through the communications system described above. For example, if the employee expresses, subsequent to taking an unscheduled and/or extra period of time away from work, that the employee is feeling refreshed or is otherwise grateful for having taken the additional time-off, the employer coordinator system 402 may assign a positive polarity to this extra time-off. As another illustrative example, if the employee expresses that they had to take an extra amount of time-off from work due to a high level of stress and/or anxiety related to their work performance, the employer coordinator system 402 may assign a negative polarity to this extra time-off.

In addition to evaluating the obtained data to identify any unscheduled and/or extra personal time-off provided to an employee over a period of time, the employer coordinator system 402 may further evaluate the obtained data to determine the impact of any personal time-off utilized by an employee during the particular time period from their traditional amount of personal time-off. For example, when an employee submits a request to utilize a portion of their personal time-off benefits within a particular period of time, and the request is approved, the employer coordinator system 402 may determine the impact the use of these available personal time-off benefits has had on the employee's organizational exhaustion. For example, if the employee expresses, subsequent to taking a scheduled period of time away from work, that the employee is feeling refreshed or is otherwise grateful for having taken this personal time-off from work, the employer coordinator system 402 may assign a positive polarity to this use of personal time-off benefits. As another illustrative example, if the employee expresses that they had to use their personal time-off benefits due to a high level of stress and/or anxiety related to their work performance, the employer coordinator system 402 may assign a negative polarity to the employee's use of their personal time-off benefits.

In some instances, the employer coordinator system 402 may further determine from the obtained data the number of denied time-off requests issued during a particular time period and corresponding to events that are deemed important to the employees whose requests were denied. The employer coordinator system 402 may process the obtained data to identify any rejected requests for personal time-off, including any dates corresponding to when these requests were submitted and to when these requests were rejected. Based on these dates, employer coordinator system 402 may identify any communications corresponding to the submission and rejection of these requests. For example, through the aforementioned communications system, the employer coordinator system 402 may identify any communications that may provide indications as to why the personal time-off was requested as well as to the sentiment of the employee upon being informed of the rejection of these requests. A negative sentiment may result in the employer coordinator system 402 assigning a higher organizational exhaustion score or metric to the rejected personal time-off request, with the impact of the rejection diminishing over time.

The employer coordinator system 402 may additionally evaluate the obtained data to identify the number of times that personal time-off requests submitted by each employee were denied in a row. For instance, the employer coordinator system 402 may count the number of denied time-off requests in a row and weigh these exponentially, with each denied request exponentially increasing the corresponding score or metric associated with the contribution of these denied requests up to a maximum allowable amount. As noted above, this score or metric may be dynamically adjusted based on the subsequent behavior of the employee, as not all employees may require or have the same perception regarding use and/or rejection of time-off requests.

As the employer coordinator system 402 determines a set of scores or metrics corresponding to the obtained data, the employer coordinator system 402 may store this set of scores or metrics in the employee database 404. Entries within the employee database 404 may correspond to the employees associated with the employer or organization. For example, an entry within the employee database 404 may be associated with a particular employee, whereby the entry may indicate any scores or metrics corresponding to the determinations made by the employee coordinator system 402 with regard to the employee's requests for personal time-off, as described above. These entries may be used by a normalization module 406 implemented by the personal time-off system 108 to aggregate and normalize any employee scores or metrics corresponding to the personal time-off events (e.g., requests and corresponding responses, unscheduled time-off, etc.) over a particular period of time (e.g., weekly, monthly, etc.) in order to determine the contribution of these events to the employee's overall organizational exhaustion. The normalization module 406 may be implemented on a computing system or other system (e.g., server, virtual machine instance, etc.) associated with the personal time-off system 108. In some instances, the normalization module 406 may be implemented as an application or other executable code that is executed on a computing system or other system associated with the personal time-off system 108.

The normalization module 406 may obtain the various entries from the employee database 404 and process the various scores and metrics corresponding to the measurements described above using linear normalization to generate a quantitative partial result corresponding to the impact that the utilization of time-off benefits (or lack thereof) has had on employees' organizational exhaustion over a period of time. For example, if the lack of usage of allocated time-off benefits described above account for 50% of an employee's organizational exhaustion, the normalization module 406 may apply a factor or weight to each normalized event score or metric such that the resulting quantitative partial result corresponding to the lack of usage of allocated time-off benefits is within a range of 0% to 50% of the possible organizational exhaustion for the employee. The normalization module 406 may provide these quantitative partial results to the optimization system 110, which may aggregate these quantitative partial results with other quantitative partial results corresponding to employee sentiments and workforce events in order to generate the quantitative values used to determine an amount of organizational exhaustion for the workforce or organization and for each employee associated with the workforce or organization.

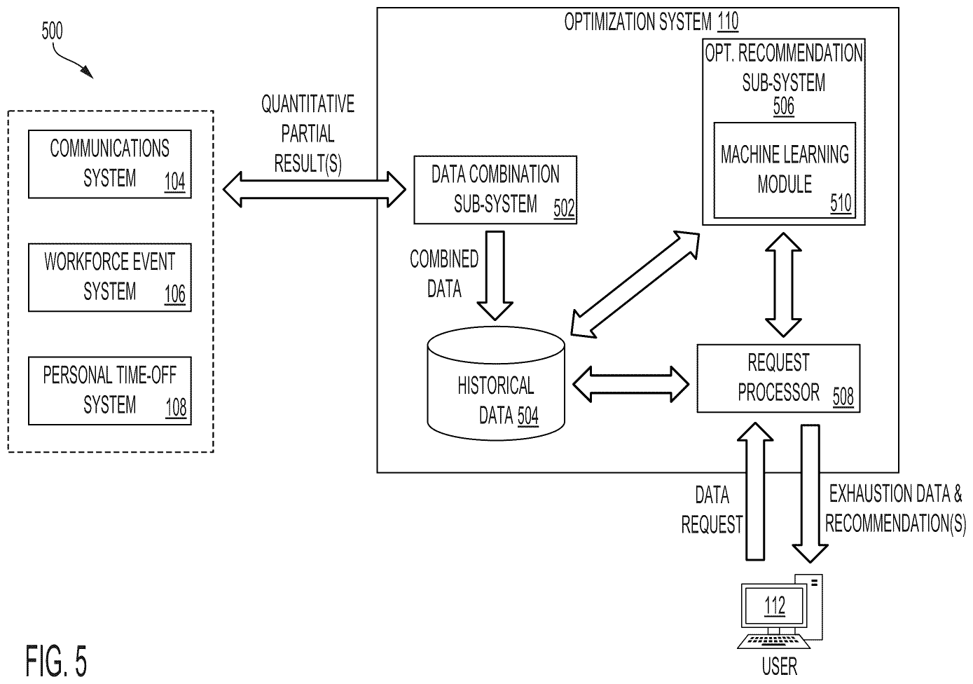

FIG. 5 shows an illustrative example of an environment 500 in which an optimization system 110 associated with a workforce optimization service aggregates data corresponding to sentiments expressed during employee communications, workforce events, and requested personal time-off data to determine an amount of organizational exhaustion for a workforce over time and to generate recommendations for addressing organizational exhaustion in accordance with at least one embodiment. In the environment 500, a data combination sub-system 502 implemented by the optimization system 110 may obtain, in real-time, quantitative partial results from the communications system 104, the workforce event system 106, and the personal time-off system 108 to determine the level of organizational exhaustion for each employee within an organization for a particular period of time (e.g., weekly, monthly, etc.). The data combination sub-system 502 may be implemented on a computing system or other system (e.g., server, virtual machine instance, etc.) associated with the optimization system 110. In some instances, the data combination sub-system 502 may be implemented as an application or other executable code that is executed on a computing system or other system associated with the optimization system 110.

In an embodiment, the data combination sub-system 502 uses a normalization table to assign a qualitative descriptor to an aggregated quantitative result corresponding to each employee's level of organizational exhaustion over a particular time period. As noted above, the normalization table may define an “engaged” category corresponding to quantitative values between 0 and 100. The “engaged” category may be used to denote that an employee is energetic, involved, and effective in performing their duties. The normalization table may further define an “overextended” category corresponding to quantitative values between 101 and 400. The “overextended” category may be used to denote that an employee is experiencing a level of fatigue and may be overworked. The normalization table may further define an “ineffective” category corresponding to quantitative values between 401 and 650. The “ineffective” category may be used to denote that an employee is being less productive within the workforce but potentially has an interest in the organization for which they are performing their duties. The normalization table may further define a “disengaged” category corresponding to quantitative values between 651 and 800. The “disengaged” category may be used to denote that an employee is unproductive, cynical, dissatisfied, and disconnected emotionally, socially, or cognitively. A quantitative value between 801 and the maximum possible value of 1,000 may correspond to the “burnout” category within the normalization table. This category may be used to denote an employee that is exhausted, chronically fatigued, cynical, dissatisfied, and ineffective at performing their duties within the organization. As noted above, it should be noted that while the aforementioned quantitative value range, normalization table categories, and corresponding sub-ranges for each of these categories are described extensively herein for the purpose of illustration, other parameters may be used to denote a level of organizational exhaustion for employees associated with the workforce or organization.

The data combination sub-system 502 may store the new aggregated quantitative results and corresponding qualitative descriptors to a historical data repository 504. The historical data repository 504 may store thereon entries corresponding to the different employees associated with an employer or organization. For example, an entry within the historical data repository 504 may indicate, for a particular employee, the amount of organizational exhaustion that the employee may be experiencing over different periods of time (e.g., weekly, monthly, etc.). By maintaining the employee's amount of organizational exhaustion (e.g., scores, metrics, etc.), any changes to the employee's organizational exhaustion may be tracked over time. The data stored in the historical data repository 504 may be made available to the optimization recommendation sub-system 506 and a request processor 508 implemented by the optimization system 110, as described in greater detail herein.

In an embodiment, a user 112 can submit a request to the request processor 508 implemented by the optimization system 110 to obtain quantitative results and corresponding qualitative descriptors corresponding to employee levels of organizational exhaustion for a set of employees. For example, if the user 112, through the request processor 508, submits a request to the optimization system 110 to obtain any scores or metrics corresponding to the level of organizational exhaustion for a particular group of employees and for a particular time range, the request processor 508 may query the historical data repository 504 storing thereon the collected quantitative results and corresponding qualitative descriptors corresponding to employee levels of organizational exhaustion over time to obtain the requested scores or metrics over the specified period of time. In an embodiment, the request processor 508 may provide the requested scores or metrics through one or more graphical interfaces, which may allow the user 112 to readily compare organizational exhaustion levels for different employees and for different employee groups in order to determine any areas of concern within the workforce.

In an embodiment, the optimization system 110, through the optimization recommendation sub-system 506, can evaluate the quantitative results and corresponding qualitative descriptors from the historical data repository 504 to provide any insights and/or recommendations regarding the level of organizational exhaustion amongst different groups of employees associated with the workforce. The optimization recommendation sub-system 506 may be implemented on a computing system or other system (e.g., server, virtual machine instance, etc.) associated with the optimization system 110. In some instances, the optimization recommendation sub-system 506 may be implemented as an application or other executable code that is executed on a computing system or other system associated with the optimization system 110.

The optimization recommendation sub-system 506 may evaluate the quantitative results and corresponding qualitative descriptors from the historical data repository 504 to identify any correlations between these quantitative results/qualitative descriptors and the various events and other data that led to these quantitative results/qualitative descriptors. Returning to a previously described illustrative example, if a particular manager within the organization consistently refuses to grant their employees' requests for personal time-off and the organizational exhaustion amongst these employees has been increasing over time as a result, the optimization recommendation sub-system 506 may generate a recommendation for the manager to be provided with remedial training or with instructions to improve their rate of granting personal time-off requests. Additionally, if there are any employees within the manager's purview that are particularly experiencing elevated levels of organizational exhaustion as a result of other factors in addition to the continued rejection of personal time-off requests, the optimization recommendation sub-system 506 may generate a recommendation for these particular employees to be granted their personal time-off requests immediately in order to address their elevated levels of organizational exhaustion. In some instances, the recommendation may be provided with various instructions or steps for addressing these other factors.

In an embodiment, the optimization recommendation sub-system 506 implements a machine learning module 510, which may include a machine learning algorithm or artificial intelligence that is dynamically trained to automatically generate recommendations in real-time for addressing organizational exhaustion associated with an employee and/or groups of employees as quantitative results are aggregated by the data combination sub-system 502. As noted above, the machine learning algorithm or artificial intelligence may be trained using supervised, unsupervised, reinforcement, or other such training techniques. For instance, the machine learning algorithm or artificial intelligence may be trained using a dataset comprising sample initial employee organizational exhaustion scores, actions performed to address employee organizational exhaustion, and revised organizational exhaustion scores. This dataset may be analyzed using the machine learning algorithm or artificial intelligence to identify correlations between different elements of the dataset without supervision and feedback.

As an example of a supervised training technique, a dataset can be selected for training of the machine learning algorithm or artificial intelligence to facilitate identification of correlations between organizational exhaustion amongst different groups of employees (based on scores and descriptors maintained in the historical data repository 504), actions performed to address this organizational exhaustion, and the impact such actions had on the organizational exhaustion amongst these different groups of employees. The machine learning algorithm or artificial intelligence may be evaluated to determine, based on the sample inputs supplied to the machine learning algorithm or artificial intelligence, whether the machine learning algorithm or artificial intelligence is producing accurate correlations between members of the dataset (e.g., given a level of organizational exhaustion for a particular employee or group of employees, the machine learning algorithm or artificial intelligence is accurately identifying the appropriate one or more actions for reducing the level of organizational exhaustion). As an illustrative example of the training of the machine learning algorithm or artificial intelligence, an evaluator of the machine learning algorithm or artificial intelligence may review the actions or recommendations identified by the machine learning algorithm or artificial intelligence to determine whether these actions or recommendations correspond to the level of organizational exhaustion for the employee or group of employees and characteristics of the employee or group of employees. To determine whether these actions or recommendations are appropriate, the evaluator may evaluate feedback corresponding to these actions or recommendations. This feedback may include later levels of organizational exhaustion associated with the selected employee or group of employees. The later levels of organizational exhaustion may indicate whether the actions or recommendations, if adhered to, led to a reduction or improvement in the levels of organizational exhaustion for the employee or group of employees. The evaluator, using these later levels of organizational exhaustion, may determine whether the actions or recommendations provided are appropriate or otherwise consistent for addressing the original levels of organizational exhaustion and associated root causes. Accordingly, based on this evaluation, the evaluator may re-train and/or improve the machine learning algorithm or artificial intelligence to improve the likelihood of the machine learning algorithm or artificial intelligence identifying appropriate actions or recommendations according to the levels of organizational exhaustion for an employee or groups of employees.

In an embodiment, the feedback used to dynamically train the machine learning algorithm or artificial intelligence included in the machine learning module 510 includes original levels of organizational exhaustion corresponding to employees and organizations associated with different companies, the actions or recommendations provided to these different companies based on the original levels of organizational exhaustion, and resulting levels of organizational exhaustion achieved as a result of adherence (or failure to adhere) to the actions or recommendations provided. For instance, as the machine learning module 510 generates different actions and/or recommendations for different companies for reducing the levels of organizational exhaustion amongst employees and organizations within these different companies, the optimization recommendation sub-system 506 may automatically monitor, in real-time, the quantitative results and corresponding qualitative descriptors associated with the impacted employees and organizations within these different companies to determine whether the different actions and/or recommendations have been adhered to and what the impact of adherence (or failure to adhere) to these different actions and/or recommendations is with regard to the organizational exhaustion associated with these impacted employees and organizations.

In an embodiment, the machine learning algorithm or artificial intelligence implemented through the machine learning module 510 is dynamically updated and re-trained continuously in real-time as recommendations and actions are provided to different companies in response to their data requests and as data corresponding to the levels of organizational exhaustion within these different companies is obtained. For instance, because various companies may be engaged with the workforce optimization service at the same time to determine the organizational exhaustion amongst employees and to obtain recommendations for addressing this organizational exhaustion, the machine learning module 510 may simultaneously, and in real-time, provide organizational exhaustion data associated with any number of different companies, along with any corresponding recommendations and/or actions, to these different companies. As a result, the optimization recommendation sub-system 506 may automatically monitor, simultaneously and in real-time, adherence to the recommendations and/or actions provided to these different companies, as well as any fluctuations to the levels of organizational exhaustion associated with these different companies. This data, as it is collected, may be used to continuously, and dynamically, update and re-train the machine learning algorithm or artificial intelligence implemented through the machine learning module 510.

If the optimization recommendation sub-system 506 provides, through the request processor 508, any recommendations generated using the machine learning algorithm or artificial intelligence, the optimization recommendation sub-system 506 may monitor the quantitative results and corresponding qualitative descriptors associated with any impacted employees to determine whether the provided recommendations (if adhered to) have resulted in the desired effect (e.g., reduction in organizational exhaustion). Further, the optimization recommendation sub-system 506 may prompt any entities associated with the impacted employees (e.g., managers, executives, user 112, etc.) to indicate whether they have implemented the provided recommendations. Based on this feedback, the optimization recommendation sub-system 506 may determine whether the provided recommendations have had the desired effect. Further, based on this determination, the optimization recommendation sub-system 506 may update or re-train the machine learning algorithm or artificial intelligence to provide the desired recommendations.

FIGS. 6A-6C show an illustrative example of an environment 600 in which various metrics corresponding to identified organizational exhaustion associated with a workforce are provided through one or more interfaces 602, 610, 634 in accordance with at least one embodiment. In the environment 600, the workforce optimization service, through the optimization system described above, may provide users with an interface 602 through which users may be provided with various scores or metrics corresponding to the organizational exhaustion amongst employees associated with an employer or organization. As noted above, the optimization system may compare the quantitative value representing the state of an employee in terms of their individual level or organizational exhaustion (e.g., burnout) against a normalization table that indicates the qualitative description for their individual level of organizational exhaustion. These qualitative descriptions may include, as noted above, an “engaged” category, an “overextended” category, an “ineffective” category, a “disengaged” category, and a “burnout” category. These qualitative descriptors may correspond to particular scores or metrics, whereby an employee score denoting their organizational exhaustion may be used to categorize the employee as being within one of the aforementioned categories for organizational exhaustion.

As illustrated in FIG. 6A, the optimization service may provide a user, through the interface 602, an employee grouping panel 604 through which the user may select a particular grouping of employees associated with an employer or organization whose organizational exhaustion a user may wish to evaluate. The different employee groupings represented in the employee grouping panel 604 may be selected based on the user's role within the workforce or organization. For example, if the user is a manager that is responsible for a particular product team associated with an employer or organization, the optimization system may present the user, within the employee grouping panel 604, an employee grouping corresponding to key employees within this particular product team, an employee grouping corresponding to the particular product team itself, and any employee groupings corresponding to different sub-teams within the product team. However, this user may not have access to data corresponding to employees outside of the particular product team. As the optimization system may have access to the employer's FIRS or an FIRS provider utilized by the employer, the optimization system may identify the user's role within the employer's organization and that of the employees within the organization and, based on this identification process, determine which employees may be under the user's purview.

In some instances, the employer or organization may define a set of policies that indicate what internal organizations or employee groupings a user is authorized to evaluate. For example, if the user is associated with an employer's human resources organization, the employer may authorize the user to review the organizational exhaustion of all employees associated with the employer. This may allow the user to identify any problematic areas within the employer's organization that may be resulting in elevated levels of organizational exhaustions amongst particular groups of employees. Thus, the employee grouping panel 604 for this user may include various employee groupings that may not be associated with the user's own internal organization (e.g., human resources) but that the user may be authorized to examine in order to identify these problematic areas.

If the user selects a particular employee grouping from the employee grouping panel 604, the optimization system may, in real-time, update the interface 602 to provide the scores or metrics corresponding to the organizational exhaustion amongst employees associated with the selected employee grouping. For example, as illustrated in FIG. 6A, as a result of the user having selected the “Company Wide” employee grouping from the employee grouping panel 604, the optimization system has updated the interface 602 to provide an organizational exhaustion breakdown for the employees within this employee grouping (e.g., the entire company). If the user selects an alternative employee grouping (e.g., “Key Employees,” “Executive,” “Finance,” “Marketing,” “Operations,” etc.) from the employee grouping panel 604, the optimization system may update the interface 602 in real-time to present an organizational exhaustion breakdown for the employees within this alternative employee grouping.

The interface 602, as illustrated in FIG. 6A, may include a historical burnout risk panel 606, through which the optimization system may present a histogram or other graphical representation of the organizational exhaustion amongst employees within a selected employee grouping over time. For example, as illustrated in FIG. 6A, through the historical burnout risk panel 606, the user may be presented with a histogram illustrating the level of organizational exhaustion company wide over the period of a year (e.g., January through December). This may allow the user to readily identify any changes to the organizational exhaustion amongst employees over this time period and, based on these changes, potentially identify trends that may be indicative of improvement or worsening of organizational exhaustion within the organization. In some instances, the optimization system may allow the user to define the particular time range for the presentation of organizational burnout through the historical burnout risk panel 606. For example, the user may be provided with various options to change the time range for presentation of historical data corresponding to the organizational exhaustion within the selected employee grouping, providing the user with flexibility to evaluate the organizational exhaustion for a selected employee grouping over different time periods and ranges.

In addition to providing a historical burnout risk panel 606, the optimization system may provide, through the interface 602, an organizational exhaustion breakdown panel 608, through which the optimization system may provide a breakdown of employee organizational exhaustion within the selected employee grouping. As illustrated in FIG. 6A, through the organizational exhaustion breakdown panel 608, the optimization system may present a pie chart or other graphical representation of employee organizational exhaustion within the selected employee grouping according to the qualitative descriptors described above. The breakdown may correspond to the present level of organization exhaustion within the selected employee grouping and may indicate the percentage of employees within the selected employee grouping experiencing different levels of organizational exhaustion. Further, the optimization system may provide the raw number of employees within the selected employee grouping that are experiencing different levels of organizational exhaustion.

The optimization system may additionally provide, in the environment 600 and as illustrated in FIG. 6B, an interface 610 through which a more granular breakdown of employee organizational exhaustion may be provided for the selected employee grouping. For example, as illustrated in FIG. 6B, for the selected employee grouping the optimization system may provide a breakdown of employee organizational exhaustion amongst employees assigned to different managers within the organization. For example, if the user has selected the “Company Wide” option from the employee grouping panel 604, the optimization system may automatically and in real-time update the interface 610 to provide a breakdown of employee organizational exhaustion amongst employees assigned to the different managers within the company. Thus, based on the employee grouping selected from the employee grouping panel 604, the optimization system may automatically identify any internal organizations within the selected employee grouping and provide an organizational exhaustion breakdown according to these internal organizations.

As illustrated in FIG. 6B, the interface 610 may include a date range drop down menu 612, through which a user may select a time range for presentation of organizational exhaustion within the selected employee grouping. For example, as illustrated in FIG. 6B, the user has used the date range drop down menu 612 to select an option to present the organizational exhaustion amongst employees within the selected employee grouping for the year up to the present day. Selection of a time range within the date range drop down menu 612 may cause the optimization system to dynamically, and in real-time, update the interfaces described herein to present the organizational exhaustion amongst employees within the selected employee grouping over the selected time range. For example, if the user selects a time range from the date range drop down menu 612, the optimization system may additionally update the historical burnout risk panel 606 and the organizational exhaustion breakdown panel 608 described above in connection with FIG. 6A to present the organizational exhaustion amongst employees within the selected employee grouping over the selected time range.

In addition to providing a date range drop down menu 612 for defining the time range for presentation of organizational exhaustion within a selected employee grouping, the optimization system, through the interface 610, may further provide a search query field 614, through which a user may submit a query for particular employees associated with employer's organization and for which the organizational exhaustion may be presented. For example, as the user enters one or more characters into the search query field 614, the optimization system may, in real-time, identify any employees that correspond to the entered one or more characters. For instance, if the user enters, into the search query field 614 “aa,” the optimization system may automatically, and in real-time, identify any employees whose names include the characters “aa,” such as “Aaron Rizzo.” If the user selects a particular employee through the search query field 614, the optimization system may automatically, and in real-time, update the interface 610 to provide a breakdown of the selected employee's organizational exhaustion, including a breakdown of the organizational exhaustion associated with other employees that may be within the selected employee's purview (e.g., if the selected employee is a manager, the optimization system may provide a breakdown of the organizational exhaustion within the manager's team, etc.).

Through the interface 610, the optimization system may provide various fields, through which the user may review the organizational exhaustion amongst different sub-groups within the elected employee grouping and other metrics that may correspond to the organizational exhaustion amongst these different sub-groups. For example, the sub-group field 616 may provide an identifier corresponding to each sub-group of the selected employee grouping for which employee organizational exhaustion may be evaluated. For instance, as illustrated in FIG. 6B, the sub-group field 616 may include the names of different managers associated with the selected organizational grouping (e.g., “Company Wide”). These managers may each manage a particular sub-group within the employer's organization and, thus, an organizational exhaustion amongst employees within each particular sub-group may be determined.

The interface 610 may further include an organizational exhaustion rate field 618, which may be used to denote the level of organizational exhaustion within each sub-group indicated through the sub-group field 616. As illustrated in FIG. 6B, the rate of organizational exhaustion may be provided as a percentage, whereby the percentage may correspond to the average level of organizational exhaustion within the sub-group. Further, a higher percentage value may denote a higher level of organizational exhaustion within the sub-group. As noted above, the optimization system may generate quantitative values used to determine an amount of organizational exhaustion for the workforce or organization and for each employee associated with the workforce or organization. Using these quantitative values, the optimization system may determine an average quantitative value corresponding to the average level of organizational exhaustion for each sub-group. As the quantitative value may be defined as a scalar value within a particular range, the optimization system may define the percentage as a function of the determined average quantitative value for the sub-group and the maximum possible quantitative value for denoting organizational exhaustion.

In an embodiment, the optimization system indicates, through the organizational exhaustion rate field 618, the average organizational exhaustion for the selected employee grouping in addition to the average organization exhaustion for each sub-group. This may allow the user to readily determine whether the average organizational exhaustion for a sub-group exceeds that of the selected employee grouping as a whole. For example, as illustrated in FIG. 6B, the average organizational exhaustion for managers Aaron Rizzo and Tony Boone (88% and 70%, respectively) may exceed the average organizational exhaustion company wide (denoted through a vertical indicator). This may indicate, to the user, that the teams managed by Aaron Rizzo and Tony Boone are experiencing heightened levels of organizational exhaustion compared to other teams within the company.

The optimization system, through the interface 610, may further provide a churn rate field 620, through which the optimization system may indicate the amount of turnover amongst employees within each sub-group. As noted above, the workforce optimization service may have access to one or more employer systems, including the employer's HRS or an HRS provider utilized by the employer. Through these one or more employer systems, the optimization system may detect events corresponding to employees within the employer's organization leaving the organization over a period of time (as denoted through the date range drop down menu 612). A high churn rate may serve as an indicator of employee dissatisfaction with the employer's organization and, thus, may indicate that the organization exhaustion within the particular sub-group needs to be addressed in order to prevent further high churn rates. Similar to the organizational exhaustion rate field 618 described above, the churn rate for each sub-group may be represented as a percentage corresponding to the amount of turnover amongst employees within each sub-group. Further, the churn rate field 620 may further indicate the average churn rate for the selected employee grouping in addition to the churn rate for each sub-group.

As noted above, the workforce optimization service, through a personal time-off system, may monitor employee requests to take personal time-off from work for different purposes (e.g., vacations, sick leave, bereavement, etc.) in order to identify possible indications of organizational exhaustion within different employee groupings. In an embodiment, the optimization system, through a sick days field 622, may indicate the number of sick days taken by employees within each sub-group over a period of time (such as the time range indicated through the date range drop down menu 612). The values provided through the sick days field 622 may be scalar and, thus, may represent the actual number of sick days taken by employees within each sub-group over the specified period of time. In some instances, employees taking an inordinate number of sick days over a particular period of time may denote organizational exhaustion within the sub-group and, thus, a value that exceeds the average number of sick days taken within the organization may be indicative of employees within the sub-group experiencing organizational exhaustion or suffering a physical and/or mental toll as a result of organizational exhaustion.

In addition to providing a sick days field 622, the optimization system may provide a personal time-off requests field 624 and a personal time-off approvals field 626, through which the optimization system may provide a user with an indication of how many personal time-off requests were submitted by employees over the specified period of time and how many of these requests were actually approved by leadership over the specified period of time. As noted above, the personal time-off system implemented by the workforce optimization service may determine the number of denied requests for time-off during a period of time for which the requests were submitted, including the number of times that personal time-off requests were denied in a row. These continued rejections, depending on employee roles within the organization, may have a detrimental impact on organizational exhaustion within the organization and particularly for employees whose time-off requests are routinely rejected. Thus, through the personal time-off requests field 624 and the personal time-off approvals field 626, the optimization system may provide metrics corresponding to the number of requests submitted over a period of time (where a higher number of requests may denote higher levels of organizational exhaustion) and the number of requests approved over the period of time (where a lower number may correspond to a high rate of rejection).

To better illustrate the difference between the number of received personal time-off requests and the number of personal time-off request approvals over the specified time period, the optimization system may provide an approval rate field 628, through which the optimization system may provide the percentage of personal time-off requests that have been approved over the specified time period. In some instances, the approval rates provided in the approval rate field 628 may not correspond to the values presented in the personal time-off requests field 624 and the personal time-off approvals field 626 as personal time-off requests received prior to the specified time range may have been approved during the specified time range, thereby impacting the values used to calculate the approval rates indicated in the approval rate field 628. A low personal time-off approval rate may serve as another indicator of possible organizational exhaustion, as employees within the corresponding sub-group may continuously have their personal time-off requests rejected, thereby requiring these employees to continue working through periods of fatigue and exhaustion.

To quantify the impact of employees not utilizing their personal time-off benefits, the optimization system, through the personal time-off liability field 630, may indicate the total personal time-off liability for each sub-group of the selected employee grouping. The total personal time-off liability for each employee may be determined using the personal time-off system and through evaluation of personal time-off data from the employer's HRS or an HRS provider utilized by the employer. The employer's personal time-off liability may be calculated by the optimization system based on the personal time-off balances for each employee of the employer's workforce and corresponding pay rates for these employees. A user may use the personal time-off liability field 630 to determine whether employees within each of the specified sub-groups are properly utilizing their available personal time-off and, if not, determine the one or more reasons that employees may not be using their available personal time-off (including heightened personal time-off rejection rates amongst leadership).

In addition to providing the personal time-off liability for each sub-group, the optimization system, through a personal time-off paid out field 632, may provide an indication of the amount of money paid out to employees as a result of these employees not being able to utilize their personal time-off benefits (e.g., employees leaving the organization, employees experienced personal time-off balance caps, etc.). A high amount of personal time-off paid out to employees may indicate that employees are not taking advantage of their personal time-off benefits and/or that employee requests to utilize their personal time-off benefits are being rejected at a high rate by management. This data may be used along with the churn rate indicated in the churn rate field 620 and the personal time-off metrics defined in the personal time-off requests field 624, the personal time-off approvals field 626, and the approval rate field 628 to define correlations between the lack of usage of personal time-off benefits and employee organizational exhaustion within each of the defined sub-groups.

The optimization system may additionally provide, in the environment 600 and as illustrated in FIG. 6C, an interface 634 through which a granular breakdown of employee organizational exhaustion may be provided for each employee within the selected employee grouping. Similar to the search query field 614 described above in connection with FIG. 6B, the optimization system, through the interface 634, may provide a search query field 636, through which a user may submit a query for a particular employee associated with employer's organization and for which the organizational exhaustion may be presented. For example, as the user enters one or more characters into the search query field 636, the optimization system may, in real-time, identify any employees that correspond to the entered one or more characters. For instance, if the user enters, into the search query field 636 “ot,” the optimization system may automatically, and in real-time, identify any employees whose names include the characters “ot,” such as “Otto Leon.” If the user selects a particular employee through the search query field 636, the optimization system may automatically, and in real-time, update the interface 634 to provide a breakdown of the selected employee's individual organizational exhaustion.

Through the interface 634, the optimization system may provide various fields, through which the user may review the organizational exhaustion amongst different individual employees within the selected employee grouping and other metrics that may correspond to the organizational exhaustion amongst these different employees. For example, the employee field 638 may provide an identifier corresponding to each employee associated with the selected employee grouping for which employee organizational exhaustion may be evaluated. For instance, as illustrated in FIG. 6C, the employee field 638 may include the names of different employees associated with the selected organizational grouping. These employees may each be a part of different sub-groups within the employer's organization.

In an embodiment, the optimization system indicates, through an organizational exhaustion risk field 640, the risk of organizational exhaustion for the corresponding employee. This may allow the user to readily determine whether an employee is at a high risk of organizational exhaustion. For example, as illustrated in FIG. 6C, the risk of organizational exhaustion for Otto Leon (92%) is particularly high, which may denote that Otto Leon is either experiencing or is at a high risk of experiencing burnout. The percentage denoted through the organizational exhaustion risk field 640 may correspond to the quantitative value corresponding to the employee's organizational exhaustion, as determined by the optimization system. For instance, as noted above, the optimization system may generate quantitative values used to determine an amount of organizational exhaustion for the workforce or organization and for each employee associated with the workforce or organization. As the quantitative value may be defined as a scalar value within a particular range, the optimization system may define the percentage as a function of the determined quantitative value for the employee and the maximum possible quantitative value for denoting organizational exhaustion of an employee.

In some instances, the employees presented through the interface 634 may be sorted according to their corresponding risk of organizational exhaustion. For example, as illustrated in FIG. 6C, the employees identified through the employee field 638 are sorted according to their corresponding risk of organizational exhaustion indicated in the organizational exhaustion risk field 640, whereby an employee having a higher risk of organizational exhaustion may be presented more prominently within the interface 634. For instance, as illustrated in FIG. 6C, because the employee “Otto Leon” has a corresponding 92% risk of organizational exhaustion, the highest amongst all employees associated with the selected employee grouping, the optimization system may present “Otto Leon” and their corresponding metrics above all other employees associated with the selected employee grouping. In some instances, the optimization system, through the organizational exhaustion risk field 640, may provide the user with an option to sort the set of employees presented through the interface 634 according to their risk of organizational exhaustion.

The interface 634 may further include a sentiment field 642, through which a user may review the sentiment expressed by each employee through their communications and actions within the organization. As noted above, the workforce optimization service, through a communications system, may aggregate an array of sentiment punctuations corresponding to employee sentiments expressed in exchanged communications over a particular period of time to determine an average sentiment score or metric that may be used to determine each employee's organizational exhaustion over a particular period of time. By determining an average sentiment score or metric that may be used to determine each employee's organizational exhaustion over this particular period of time, the communications system may normalize each employee's sentiment over the particular period of time and obtain quantitative partial results corresponding to the contribution that each employee's sentiment has on their organizational exhaustion. Using these quantitative partial results, the optimization system may determine each employee's average sentiment over the specified period of time. The qualitative indication of each employee's sentiment indicated within the sentiment field 642 may correspond to the linear normalizer result generated by the communications system based on the sentiments expressed through the processed communications associated with each employee. Thus, through the sentiment field 642, a user may readily determine each employee's sentiment in terms of a qualitative descriptor.

In some instances, the interface 634 may include a manager field 644, through which the optimization system may indicate who each employee's manager or other supervisor may be. The managers or other supervisors indicated in the manager field 644 may correspond to the names of different managers or other supervisors associated with the selected organizational grouping indicated in the sub-group field 616 described above. The manager field 644 may allow the user to readily identify any trends associated with a particular manager or other supervisor that may correspond to managerial creation of organizational exhaustion amongst their employees. For example, if employees associated with a particular manager indicated through the manager field 644 have consistently exhibited a high risk of organizational exhaustion (as indicated through the organizational exhaustion risk field 640), the user may determine that the manager or other supervisor may be a contributing factor to the organizational exhaustion associated with their employees. This may guide the user to engage the manager or other supervisor in order to reduce the organizational exhaustion within the manager's employees.

The interface 634 may further include a last time off field 646, which may be used to indicate the last time an employee has taken personal time off from their work. As noted above, the optimization system, in determining the organizational exhaustion for a particular employee and through the personal time-off system described above, may determine any rejected requests for personal time-off, including any dates corresponding to when these requests were submitted and to when these requests were rejected. Further, the optimization system, through the personal time-off system described above, may identify the number of times that personal time-off requests submitted by an employee were denied in a row. From this data, the optimization system may determine the last time an employee has taken time off, which may be indicated through the last time off field 646. Further, through a last request field 648, the optimization system may indicate when the employee last made a request to take time off. These values may serve as indicators of whether the employee has taken advantage of their personal time off benefits and, if not, whether this was a result of their requests being continuously denied by their manager or other supervisor or due to other circumstances (e.g., important work projects requiring the employee's presence, etc.).

The optimization system, through the interface 634, may further provide a personal time-off balance field 650. Through the personal time-off balance field 650, the optimization system may indicate the present personal time-off benefit balance for each employee indicated in the employee field 638. A sizable balance within the personal time-off balance field 650 may serve as an indication that the corresponding employee has not been able to use their personal time-off balance. This value may be correlated with the values within the last time off field 646 and the last request field 648 to illustrate the possible causes for the employee being unable to take advantage of their personal time-off balance. Thus, the various metrics provided through the interface 634 may be used to identify connections between these different metrics and better identify the root causes for employees being unable to utilize their personal time-off benefits and for the risk of organizational exhaustion exhibited by these employees.

Similar to the interface 610 described above, the optimization system may provide a personal time-off liability field 652 through the interface 634. The personal time-off liability field 652 may be used to quantify the impact of each employee not utilizing their personal time-off benefits. Thus, the personal time-off liability field 652 may indicate the total personal time-off liability for each employee. The total personal time-off liability for each employee may be determined using the personal time-off system and through evaluation of personal time-off data from the employer's HRS or an HRS provider utilized by the employer. The employer's personal time-off liability may be calculated by the optimization system based on the personal time-off balances for each employee of the employer's workforce and corresponding pay rates for these employees. Thus, the personal time-off liability field 652 may provide the user with a more granular detail regarding the personal time-off liability per employee resulting from their use (or lack thereof) of their personal time-off benefits.

FIG. 7 shows an illustrative example of an environment 700 in which a comparison of organizational exhaustion between a manager and a workforce is provided through an interface 702 in accordance with at least one embodiment. In the environment 700, through the optimization system, a user may select a particular manager or other supervisor that may be responsible for one or more employees associated with the employer. For example, through the sub-group field 616 described above in connection with FIG. 6B, a user may select a particular manager or other supervisor that the user would like to compare to the workforce or organization as a whole or to the particular employee grouping selected by the user through the employee grouping panel 604 described above in connection with FIG. 6A.

In some instances, the optimization system may allow the user to compare the particular manager or other supervisor to other workforces or organizations within a relevant industry. As noted above, the workforce optimization service may anonymize the scores or metrics corresponding to the level of organization exhaustion for different groups of employees and organizations to provide industry benchmarks of organization exhaustion across different industries. These other groups of employees and organizations may be associated with the workforce optimization service and, thus, the workforce optimization service (through the systems and methods described herein) may maintain scores or metrics corresponding to the levels of organizational exhaustion for these other groups of employees and organizations. The user, through the optimization system, may select any other group of employees and/or organizations associated with the workforce optimization service to compare any scores or metrics associated with the particular manager or other supervisor to that of any other group of employees and/or organizations. This may allow the user to perform benchmarking analysis of the organizational exhaustion across different groups and organizations.

If the user selects a particular manager or other supervisor through the sub-group field 616 described above, the optimization system may present the user with an interface 702 through which the optimization system may provide a graphical representation of a comparison between the selected manager or other supervisor and the employee grouping selected by the user and that the manager or other supervisor may belong to. As illustrated in FIG. 7, the graphical representation of this comparison may include a linear plot over a particular period of time denoting changes to a particular metric over this particular period of time. For instance, as illustrated in FIG. 7, the user may use a drop down menu 706 to select the particular metric for which the user would like to compare the selected manager or other supervisor to the selected employee grouping. Selection of a particular metric through the drop down menu 706 may cause the optimization system to dynamically update the interface 702 in real-time to present a linear plot over the selected time period for the selected metric.

The linear plot presented through the interface 702 may include a line 708 corresponding to the selected manager or other supervisor and a line 710 corresponding to the employee grouping originally selected by the user. Further, the interface 702 may include a legend 704 that may be used by the user to identify and differentiate the lines 708, 710 presented through the interface 702. As an illustrative example and as illustrated in FIG. 7, the user has opted to compare the burnout rate for the employees assigned to the manager “Lisa Mathewson” to the average burnout rate for the entire company. Accordingly, through the linear plot, the user may readily determine the difference between the average burnout rate amongst Lisa Mathewson's employees and that of the company as a whole to identify any possible areas of concern with regard to Lisa Mathewson's group. For example, for the months of January, February, and April, the average burnout rate for Lisa Mathewson's team exceeded that of the company as a whole, which may denote an issue within those months. However, given that the average burnout rate after April has consistently remained below the company average, the user may readily determine that there is little concern with regard to burnout within Lisa Mathewson's group. If corrective measures were taken to address burnout within this group, the user may use this information as an indication that these measures may be effective for other teams within the company.

Thus, through the interface 702, a user may readily identify any possible areas of concern amongst sub-groups associated with the selected employee grouping and identify possible solutions to these issues. Further, if improvement is detected over time as a result of implementation of one or more measures, the user may proceed to implement these measures for any other sub-groups that may be experiencing similar issues.

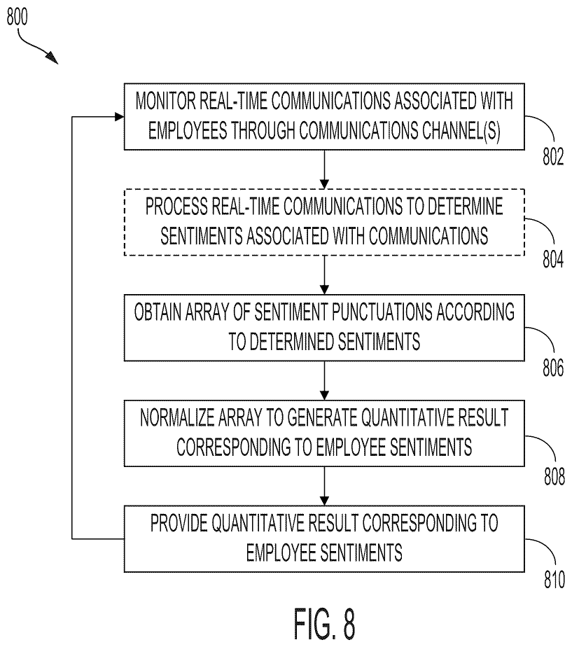

FIG. 8 shows an illustrative example of a process 800 for monitoring employee communications in real-time across different communications channels to identify a set of sentiments associated with the employee communications to determine contributions to organizational exhaustion in accordance with at least one embodiment. The process 800 may be performed by a communications system implemented by the workforce optimization service. As noted above, the communications system may process, in real-time, employee communications exchanged via different communications channels in order to determine employee sentiments and their contribution to each employee's organizational exhaustion over time.

At step 802, the communications system may monitor, in real-time, communications associated with employees exchanged through different communications channels. For instance, the communications system may obtain, in real-time, raw communications data from one or more communications sources. This raw communications data may include communications exchanged through various communications channels, including electronic mail servers, chat sessions, voice conversations (e.g., telephonic and/or VoIP), and the like. As noted above, these communications sources may include any communications systems and/or services that may be operated by an employer or other organization that employs these employees. Additionally, the one or more communications sources may include any third-party communications systems and/or services that may not be associated with the employer or other organization but that otherwise may provide employees associated with the employer or other organization with one or more communications channels for communicating with other employees and/or other entities that may not be associated with the employer or other organization. If the communications sources include any third-party communications systems and/or services that are not associated with the employer or other organization, employees may be required to provide authorization for the communications system to monitor any communications sessions associated with these employees and implemented through these third-party communications systems and/or services.

At step 804, the communications system may process the communications data in real-time to determine any corresponding sentiments expressed by the employees through their respective communications sessions. In an embodiment, the communications system implements a machine learning algorithm or artificial intelligence that is dynamically trained to perform a semantic analysis of the communications data in real-time as the communications data is received from the one or more communications sources. The machine learning algorithm or artificial intelligence may be dynamically trained to identify, from communications exchanged through different communications channels, keywords, sentence structures, repeated words, punctuation characters and/or non-article words and the like in order to identify employee sentiments expressed through these communications. The machine learning algorithm or artificial intelligence may be dynamically trained may be dynamically trained using a dataset of input communications and known sentiments expressed in the input communications. The machine learning algorithm or artificial intelligence may be evaluated to determine, based on the input sample communications supplied to the machine learning algorithm or artificial intelligence, whether the machine learning algorithm or artificial intelligence is extracting the expected sentiments from each of these communications. Based on this evaluation, the machine learning algorithm or artificial intelligence may be modified or re-trained to increase the likelihood of the machine learning algorithm or artificial intelligence generating the desired results. The machine learning algorithm or artificial intelligence may further be dynamically trained by soliciting feedback from users with regard to the extracted sentiments obtained from exchanged communications. In some instances, the machine learning algorithm or artificial intelligence may include NLP, which can process both textual and audial communications to identify the keywords, sentence structures, repeated words, punctuation characters and/or non-article words and the like expressed within each communication in real-time.

It should be noted that, in some instances, the machine learning algorithm or artificial intelligence may be implemented by one or more third-party service providers, whereby the communications system may, in real-time, maintain a data stream or feed through which communications data associated with real-time communications is provided to the one or more third-party service providers in real-time for extraction of sentiments from these real-time communications. If the machine learning algorithm or artificial intelligence is implemented by one or more third-party service provides, step 804 may be performed by these one or more third-party service providers as opposed to the communications system. Thus, in these instances, the process 800 may be performed without the communications system processing the real-time communications data to determine employee sentiments at step 804.

At step 806, the communications system may obtain an array of sentiment punctuations according to the determined sentiments. As noted above, the machine learning algorithm or artificial intelligence may provide, as output, a set of scores or metrics corresponding to employee sentiments expressed, in real-time, through various communications channels associated with the one or more communications sources. This set of scores or metrics may be provided in the form of an array of sentiment punctuations. For example, the machine learning algorithm or artificial intelligence may provide a score or metric for each communication processed, whereby the score or metric may correspond to a sentimental state of the corresponding employee. As an illustrative example, the resulting score or metric for a particular communication may range from 0.0 (denoting an “extremely unsatisfied” sentiment) to 10.0 (denoting an “extremely satisfied” sentiment). Each score or metric for the set of communications processed using the machine learning algorithm or artificial intelligence may be provided in an array, whereby an entry in the array may correspond to a communication and the corresponding employee that submitted the communication. This may allow the communications to aggregate these scores or metrics per employee in order to determine the overall sentiment score for the employee over a particular time period.

At step 808, the communications system may normalize the array of sentiment punctuations to generate a quantitative result corresponding to employee sentiments. As noted above, the communications system may aggregate the array of sentiment punctuations corresponding to employee sentiments expressed in the exchanged communications over a particular period of time to determine an average sentiment score or metric that may be used to determine each employee's organizational exhaustion over this particular period of time. By determining an average sentiment score or metric that may be used to determine each employee's organizational exhaustion over this particular period of time, the communications system may normalize each employee's sentiment over the particular period of time and obtain quantitative partial results corresponding to the contribution that each employee's sentiment has on their organizational exhaustion. In some instances, the normalized sentiment score or metric for an employee may be adjusted according to a factor or weight determined based on the contribution of the employee's sentiment to the overall organizational exhaustion for the employee.

At step 810, the communications system may provide these quantitative partial results to the optimization system. As noted above, the optimization system may aggregate these quantitative partial results with other quantitative partial results corresponding to workforce events and requested personal time-off data in order to generate the quantitative values used to determine an amount of organizational exhaustion for the workforce or organization and for each employee associated with the workforce or organization.

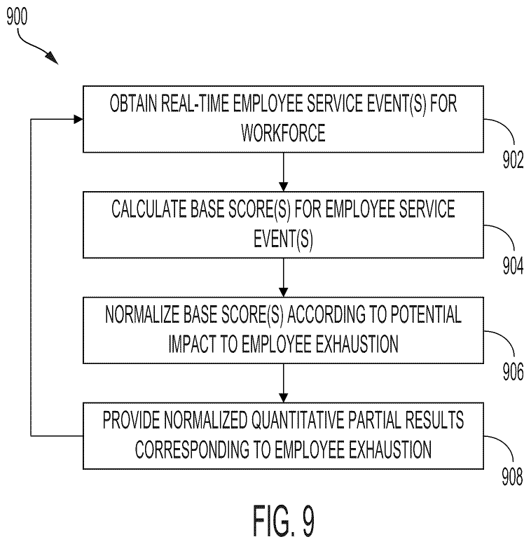

FIG. 9 shows an illustrative example of a process 900 for calculating a set of scores corresponding to employee service events in real-time to determine contributions to organizational exhaustion in accordance with at least one embodiment. The process 900 may be performed by a workforce event system implemented by the workforce optimization service. As noted above, the workforce event system may, in real-time, process time series data from one or more employer systems to identify any events associated with a set of employees to identify any indications of organizational exhaustion.

At step 902, the workforce event system may obtain, in real-time, employee service events for a workforce associated with an employer or other organization. For instance, the workforce event system may obtain, in real-time, time series data from one or more employer systems. The one or more employer systems may include employer payroll systems, employer timekeeping systems, HRS, an HRS provider utilized by an employer, and the like. In some instances, the one or more employer systems may further include one or more communications sources. The time series data may correspond to employee events occurring within the organization that may have an impact on an employee's organizational exhaustion. For instance, the time series data may include data corresponding to the time elapsed between clock-in and clock-out events for an employee over a particular period of time. Further, the time series data may include any periods of rest between clock-in and clock-out events, whereby an employee may enjoy a break period during workdays, not including any usage of personal time-off benefits.

In some instances, the workforce event system may compare the time series data to known employee work schedules such that the workforce event system may automatically, and in real-time, determine when an employee is working beyond their defined work schedule and/or has continued to work without a break period. Additionally, the workforce event system may cross-reference the time series data with organization and employee calendars to determine if an employee is working on holidays, during blackout periods, during a scheduled vacation or other personal time-off period, or otherwise outside of their regular or formal schedule. In some instances, in conjunction with the aforementioned communications system or independently, the workforce event system may identify any communications that are indicative of an employee performing any tasks outside of their regular/formal schedule or during a scheduled time off.

In some instances, the workforce event system may compare the obtained time series data to the required number of active employees for the workforce associated with each employee (e.g., product team, internal organization, business unit, etc.). Through this comparison, the workforce event system may detect any discrepancies between the number of current, active employees within the workforce and the required number of active employees. Further, the workforce event system may measure the quantity of activities per employee while taking into consideration the employee's role within the organization by measuring the number and complexity of these activities over a period of time given the employee's assigned role.

The time series data obtained by the workforce event system may be further used to identify any deviations in employee salaries compared to peers within the organization and to peers employed by other similarly-situated organizations (e.g., other companies, etc.) and to identify any employee salary increases over a particular period of time. For example, the workforce event system, for each employee, may measure the employee's wage based on their role and against wages associated with their colleagues within the organization and other similarly-situated organizations (e.g., other companies having similar employee roles, etc.), as well as evaluate any communications associated with the employee to determine their sentiment with regard to their present wage or salary. Further, if the workforce event system detects an increase in an employee's salary, the workforce event system may assign a score that denotes a reduction in the employee's organizational exhaustion over a period of time.

In some instances, the workforce event system may further evaluate the time series data from the one or more employer systems to measure the elapsed time between the start of employee activities or tasks and the end or change in status of these employee activities or tasks in order to identify any employee delays in the performance of these activities or tasks, as well as any errors or rollbacks associated with these activities or tasks. For example, the workforce event system may compare the elapsed time in performance of an activity or task to the expected amount of time required for performance of the activity or task. The expected amount of time may be determined based on schedules or calendars maintained by the organization (e.g., Gantt charts, project schedules, scrum boards, Kanban boards, etc.). Further, the workforce event system may determine a rate of errors and rollbacks over a period of time, where a higher rate of error may correspond with a higher level of organizational exhaustion.

At step 904, the workforce event system may calculate a set of base scores for the various employee service events detected through evaluation of the time series data. As noted above, each identified event may be assigned a corresponding score, where the score may correspond to the potential impact of the event on an employee's level of organizational exhaustion. These base scores may be aggregated in order to obtain an aggregate score or metric for each employee, where the aggregate score or metric may correspond to the contribution of the identified events to the employee's organizational exhaustion.

At step 906, the workforce event system may normalize these base scores according to the potential impact these events may have on each employee's organizational exhaustion. For instance, the workforce event system, through a normalization module, may process the various base scores and metrics corresponding to the measurements described above using linear normalization to generate a quantitative partial result corresponding to the impact these particular workforce events have had on employees' organizational exhaustion over a period of time. For instance, based on a pre-defined contribution of workforce events to the overall organizational exhaustion of employees, the workforce event system may apply a factor or weight to each normalized event score or metric such that the resulting quantitative partial result corresponding to events associated with an employee sentiment is within the pre-defined contribution range.

At step 908, the workforce event system may provide the determined quantitative partial results to the optimization system. As noted above, the optimization system may aggregate these quantitative partial results with other quantitative partial results corresponding to employee sentiments and requested personal time-off data in order to generate the quantitative values used to determine an amount of organizational exhaustion for the workforce or organization and for each employee associated with the workforce or organization.

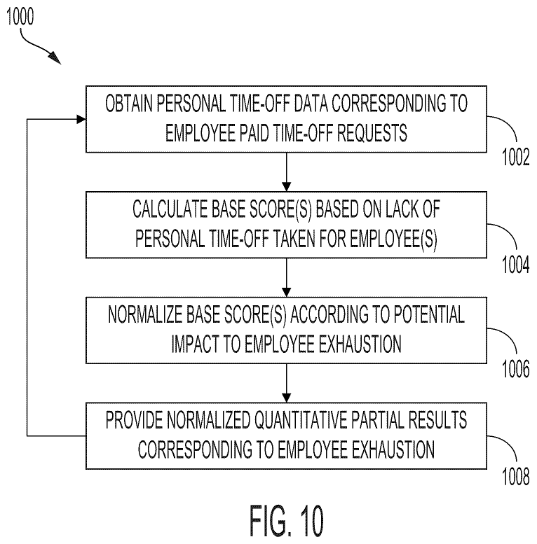

FIG. 10 shows an illustrative example of a process 1000 for calculating a set of scores corresponding to employee personal time-off requests in real-time to determine contributions to organizational exhaustion in accordance with at least one embodiment. The process 1000 may be performed by a personal time-off system implemented by the workforce optimization service. As noted above, the personal time-off system may process personal time-off benefit requests and corresponding responses obtained from one or more employer systems to identify any indications of organizational exhaustion amongst employees associated with a particular employer or organization.

At step 1002, the personal time-off system may obtain, in real-time, personal time-off data corresponding to employee personal time-off requests. For instance, the personal time-off system may obtain, in real-time, employee information from one or more employer systems associated with an employer. The one or more employer systems may include the employer's HRS or an HRS provider utilized by the employer. The employee information obtained from these one or more employer systems may include employee identifiers, employee wage information, employee personal time-off balances, and the like.

At step 1004, the personal time-off system may calculate a set of base scores for employees associated with the employer or other organization based on the lack of personal time-off taken by these employees. For instance, personal time-off system may evaluate the personal time-off data obtained in real-time to determine, for each employee associated with an employer or organization, the last time a request to utilize a personal time-off benefit was approved. For instance, the personal time-off system may identify, from the personal time-off data, any communications or entries corresponding to employee requests for use of a personal time-off benefit, as well as any obtained approvals of any of these employee requests for personal time off from work. This may include approvals for personal time-off associated with vacations, rest days, family leave, and the like. As the amount of time from the previously approved request increases, the personal time-off system may assign an increasing score or metric that may be indicative of an employee's lack of personal time-off over time.

As noted above, the personal time-off system may further evaluate the personal time-off data to identify any unscheduled and/or extra personal time-off provided to an employee over a period of time. The personal time-off system may automatically process the personal time-off data to determine the amount of additional time-off provided to an employee during a particular time period and that may have been provided outside of the traditional amount of personal time-off that is assigned to the employee or that the employee otherwise has accrued over time. This additional time-off may be provided, for example, as a result of a sudden event that requires the employee to be away from their employment. The impact of this additional time-off to an employee's organizational exhaustion may be determined based on any communications exchanged by the employee with others within the organization and other entities, such as through the communications system described above.

The personal time-off system may further evaluate the obtained personal time-off data to determine the number of denied time-off requests issued during a particular time period and corresponding to events that are deemed important to the employees whose requests were denied. The personal time-off system may process the personal time-off data to identify any rejected requests for personal time-off, including any dates corresponding to when these requests were submitted and to when these requests were rejected. Based on these dates, personal time-off system may identify any communications corresponding to the submission and rejection of these requests. These communications may provide indications as to why the personal time-off was requested as well as to the sentiment of the employee upon being informed of the rejection of these requests. Based on this sentiment, the personal time-off system may assign an organizational exhaustion score or metric to the rejected personal time-off request.

Additionally, the personal time-off system may further evaluate the personal time-off data to identify the number of times that personal time-off requests submitted by each employee were denied in a row. The personal time-off system may count the number of denied time-off requests in a row and weigh these exponentially, with each denied request exponentially increasing the corresponding score or metric associated with the contribution of these denied requests up to a maximum allowable amount. The personal time-off system may further evaluate each employee's subsequent behavior to determine whether to dynamically adjust the score or metric. As noted above, not all employees may require or have the same perception regarding use and/or rejection of time-off requests. Thus, the impact to an employee's organizational exhaustion resulting from rejected personal time-off requests may differ by employee.

At step 1006, the personal time-off system may normalize the calculated base scores according to their potential impact to each employee's organizational exhaustion. For instance, through a normalization module implemented by the personal time-off system, the personal time-off system may aggregate and normalize any employee scores or metrics corresponding to the personal time-off events (e.g., requests and corresponding responses, unscheduled time-off, etc.) over a particular period of time (e.g., weekly, monthly, etc.) in order to determine the contribution of these events to the employee's overall organizational exhaustion. Further, the personal time-off system may process these scores or metrics using linear normalization to generate a quantitative partial result corresponding to the impact that the utilization of time-off benefits (or lack thereof) has had on employees' organizational exhaustion over a period of time.

At step 1008, the personal time-off system may provide the determined quantitative partial results to the optimization system. As noted above, the optimization system may aggregate these quantitative partial results with other quantitative partial results corresponding to employee sentiments and workforce events in order to generate the quantitative values used to determine an amount of organizational exhaustion for the workforce or organization and for each employee associated with the workforce or organization.

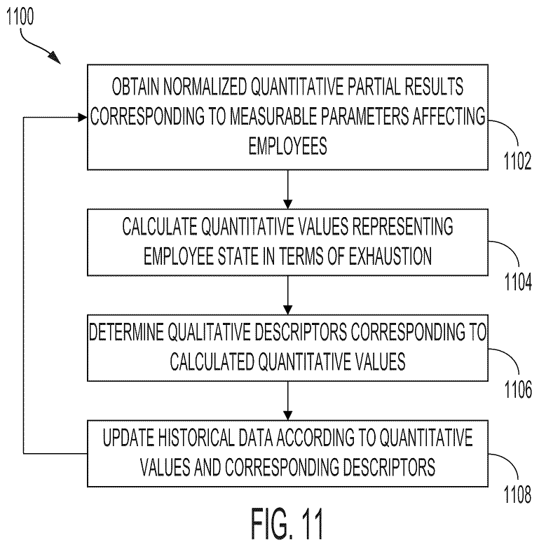

FIG. 11 shows an illustrative example of a process 1100 for calculating quantitative values representing employee states associated with organizational exhaustion and for determine qualitative descriptors for these quantitative values in accordance with at least one embodiment. The process 1100 may be performed by an optimization system implemented by the workforce optimization service. As noted above, the optimization system may aggregate data corresponding to sentiments expressed during employee communications, workforce events, and requested personal time-off data to determine an amount of organizational exhaustion for a workforce over time and to generate recommendations for addressing the amount of organizational exhaustion.

At step 1102, the optimization system may obtain the normalized quantitative partial results corresponding to the measurable parameters affecting employee organizational exhaustion. For instance, the optimization system may obtain, in real-time, quantitative partial results from the communications system, the workforce event system, and the personal time-off system to determine the level of organizational exhaustion for each employee within an organization for a particular period of time (e.g., weekly, monthly, etc.). As noted above, the quantitative partial results may have different ranges corresponding to their contribution to the overall organizational exhaustion for each employee. For example, the resulting quantitative partial result corresponding to an employee's sentiment may be within a range of −30% to 30% of the possible organizational exhaustion for the employee (e.g., −300 to 300 points). The resulting quantitative partial result may be negative, as a positive employee sentiment may provide a positive impact against organizational exhaustion, thereby reducing the employee's overall organizational exhaustion score or metric. As another example, the resulting quantitative partial result corresponding to workforce events associated with an employee may be within a range of 0% to 20% of the possible organizational exhaustion for the employee (e.g., 0 to 200 points). As yet another illustrative example, the resulting quantitative partial result corresponding to the lack of usage of time-off benefits may be within a range of 0% to 50% of the possible organizational exhaustion for the employee (e.g., 0 to 500 points).

At step 1104, the optimization system may calculate the quantitative values representing each employee's state in terms of their organizational exhaustion. For example, the optimization system may aggregate the obtained quantitative partial results to obtain an overall organizational exhaustion score for each employee over a particular period of time. For instance, if a particular employee has obtained a score of −243 based on their average sentiment, a score of 117 based on the identified workforce events associated with the employee, and a score of 276 based on their lack of usage of time-off benefits allocated to the employee, the optimization system may sum these scores together to obtain an overall organizational exhaustion score of 150 out of a possible score of 1,000. The optimization system may perform this score aggregation for each employee associated with the employer or other organization.

At step 1106, the optimization system may determine the qualitative descriptors corresponding to the calculated quantitative values for the overall organizational exhaustion of each employee. For instance, the optimization system may use a normalization table to assign a qualitative descriptor to an aggregated quantitative result corresponding to each employee's level of organizational exhaustion over a particular time period. The normalization table may define an “engaged” category corresponding to quantitative values between 0 and 100. The “engaged” category may be used to denote that an employee is energetic, involved, and effective in performing their duties. The normalization table may further define an “overextended” category corresponding to quantitative values between 101 and 400. The “overextended” category may be used to denote that an employee is experiencing a level of fatigue and may be overworked. The normalization table may further define an “ineffective” category corresponding to quantitative values between 401 and 650. The “ineffective” category may be used to denote that an employee is being less productive within the workforce but potentially has an interest in the organization for which they are performing their duties. The normalization table may further define a “disengaged” category corresponding to quantitative values between 651 and 800. The “disengaged” category may be used to denote that an employee is unproductive, cynical, dissatisfied, and disconnected emotionally, socially, or cognitively. A quantitative value between 801 and the maximum possible value of 1,000 may correspond to the “burnout” category within the normalization table. This category may be used to denote an employee that is exhausted, chronically fatigued, cynical, dissatisfied, and ineffective at performing their duties within the organization. Thus, based on the overall organizational exhaustion score determined for each employee, the optimization system may apply a corresponding qualitative descriptor that corresponds to the score.

At step 1108, the optimization system may update the historical data according to the obtained quantitative values corresponding to the overall organizational exhaustion for each employee and the corresponding qualitative descriptors for each of these quantitative values. For instance, the optimization system may store the new aggregated quantitative results and corresponding qualitative descriptors to a historical data repository, which may store thereon entries corresponding to the different employees associated with an employer or organization. An entry within this repository may indicate, for a particular employee, the amount of organizational exhaustion that the employee may be experiencing over different periods of time, which may allow for detecting any changes to the employee's organizational exhaustion over time. Thus, the process 1100 may be continuously performed to obtain up-to-date and real-time aggregated quantitative results and corresponding qualitative descriptors for each employee.

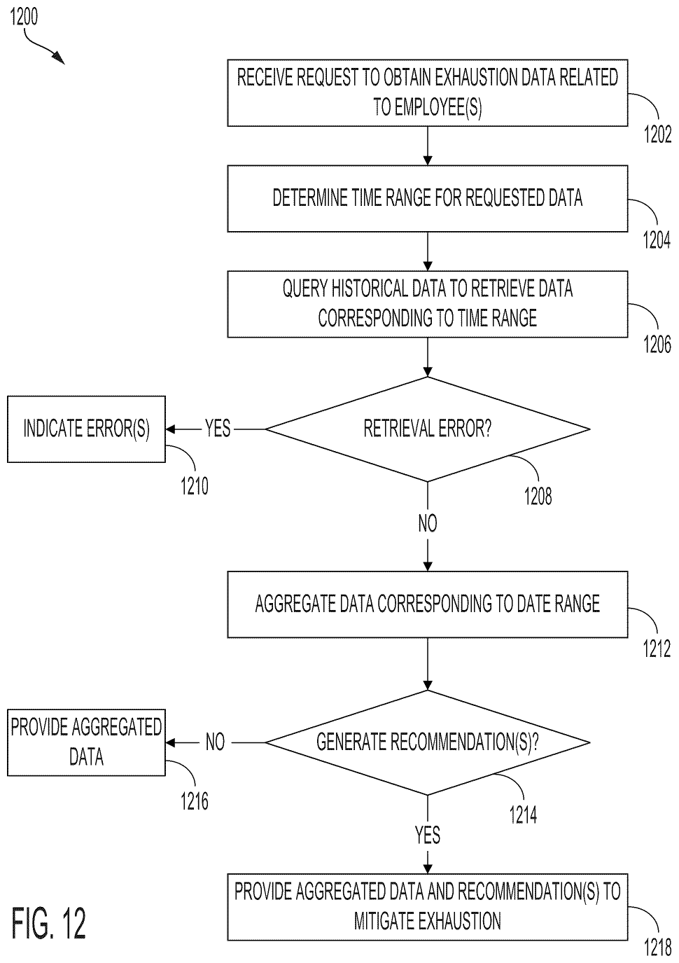

FIG. 12 shows an illustrative example of a process 1200 for providing aggregated data corresponding to organizational exhaustion corresponding to a set of employees and recommendations for addressing the organizational exhaustion in accordance with at least one embodiment. The process 1200 may be performed by the optimization system implemented by the workforce optimization service. As noted above, the optimization system may provide one or more interfaces through which the optimization system may provide user with various scores or metrics corresponding to the organizational exhaustion for one or more employees associated with an employer or other organization. Further, in some instances, the optimization system may provide one or more recommendations to these users for addressing the level of organizational exhaustion for the one or more employees.

At step 1202, the optimization system may receive a request to obtain organizational exhaustion data associated with one or more employees. As noted above, a user may submit a request to the optimization system to obtain quantitative results and corresponding qualitative descriptors corresponding to employee levels of organizational exhaustion for a set of employees. The request may indicate the employees for which the user is requesting scores or metrics corresponding to the level of organizational exhaustion for these employees, as well as a particular time range for which the scores or metrics may be obtained. Based on the time range defined by the user, the optimization system, at step 1204, may determine the time range for the requested data. In some instances, if the user does not indicate a time range for obtaining the requested quantitative results and corresponding qualitative descriptors, the optimization system may automatically use a default time range (e.g., six months, one year, two years, etc.) for obtaining the requested quantitative results and corresponding qualitative descriptors.

At step 1206, the optimization system may query a historical data repository to retrieve the requested data for the indicated (or default) time range. As noted above, an entry within the historical data repository may indicate, for a particular employee, the amount of organizational exhaustion that the employee may be experiencing over different periods of time (e.g., weekly, monthly, etc.). Thus, the optimization system may use any provided identifiers corresponding to the employees that the user is requesting organizational exhaustion scores for and the determined time range to query the historical data repository for the requested data.

At step 1208, the optimization system may determine whether there is a retrieval error in obtaining the requested data from the historical data repository. For example, if the historical data repository does not maintain any data corresponding to the indicated employees, the optimization system, at step 1210, may indicate one or more errors, including an indication that there is no record corresponding to the indicated employees. As another illustrative example, if the historical data repository does not maintain any data corresponding to the indicated (or default) time range for the indicated employees, the optimization system, at step 1210, may indicate one or more errors, including an indication that there is no available data for the provided time range. In some instances, rather than providing an error, the optimization system may retrieve any available data for the specified employees, regardless of the time range.

As noted above, the employer or organization may define a set of policies that indicate what internal organizations or employee groupings a user is authorized to evaluate. For example, if the user is associated with an employer's human resources organization, the employer may authorize the user to review the organizational exhaustion of all employees associated with the employer. Alternatively, if the user is a manager of a particular group of employees, the employer may authorize the user to review the organizational exhaustion of only those employees within the particular group. Thus, in querying the historical data repository to obtain the requested data, the optimization system may further determine, based on this set of policies, whether the user is authorized to obtain the requested data for the indicated employees. If the user is not authorized to obtain this data for the indicated employees, the optimization system, at step 1210, may indicate an error to the user, whereby the optimization system may indicate that the user is not authorized to review such data for the indicated employees.

If the optimization system is able to retrieve the requested data from the historical data repository, the optimization system, at step 1212, may aggregate this data according to the time range indicated in the user's request. For instance, the optimization system may generate one or more histograms, tables, charts, and other graphical representations of the obtained organizational exhaustion data for the indicated employees over the specified time range. Further, if the user has indicated that they would like to review the organizational exhaustion data for a particular employee grouping, the optimization system may aggregate the organizational exhaustion data for the employees within the employee groupings, as well as aggregating the organizational exhaustion data along any sub-groups corresponding to the specified employee grouping.

At step 1214, the optimization system may determine whether to generate one or more recommendations for addressing the organizational exhaustion amongst the one or more employees indicated in the request. For instance, the optimization system may be implemented to solely provide the requested organizational exhaustion data for the indicated one or more employees through one or more interfaces, such as the interfaces described above in connection with FIGS. 6A-6C. Through these interfaces, the user may readily compare organizational exhaustion levels for different employees and for different employee groups in order to determine any areas of concern within the workforce. Thus, if the optimization system is implemented to solely provide the requested organizational exhaustion data, the optimization system, at step 1216, may provide the aggregated data through the aforementioned interfaces.

As noted above, the optimization system, in some instances, may be implemented to evaluate the quantitative results and corresponding qualitative descriptors from the historical data repository to provide any insights and/or recommendations regarding the level of organizational exhaustion amongst different groups of employees associated with the employer. For instance, the optimization system may evaluate the quantitative results and corresponding qualitative descriptors from the historical data repository to identify any correlations between these quantitative results/qualitative descriptors and the various events and other data that led to these quantitative results/qualitative descriptors. In some instances, the optimization system may implement a machine learning algorithm or artificial intelligence that is dynamically trained to automatically generate recommendations in real-time for addressing organizational exhaustion associated with an employee and/or groups of employees as quantitative results are aggregated by the optimization system. Thus, at step 1218, the optimization system may provide the aggregated data and these recommendations to the user for mitigation of organizational exhaustion associated with the indicated employee.

In some instances, if the optimization system provides any recommendations generated using the machine learning algorithm or artificial intelligence, the optimization system may monitor the quantitative results and corresponding qualitative descriptors associated with any impacted employees to determine whether the provided recommendations (if adhered to) have resulted in the desired effect (e.g., reduction in organizational exhaustion). Further, the optimization system may prompt any entities associated with the impacted employees (e.g., managers, executives, etc.) to indicate whether they have implemented the provided recommendations. Based on this feedback, the optimization system may determine whether the provided recommendations have had the desired effect. Further, based on this determination, the optimization system may update or re-train the machine learning algorithm or artificial intelligence to provide the desired recommendations.

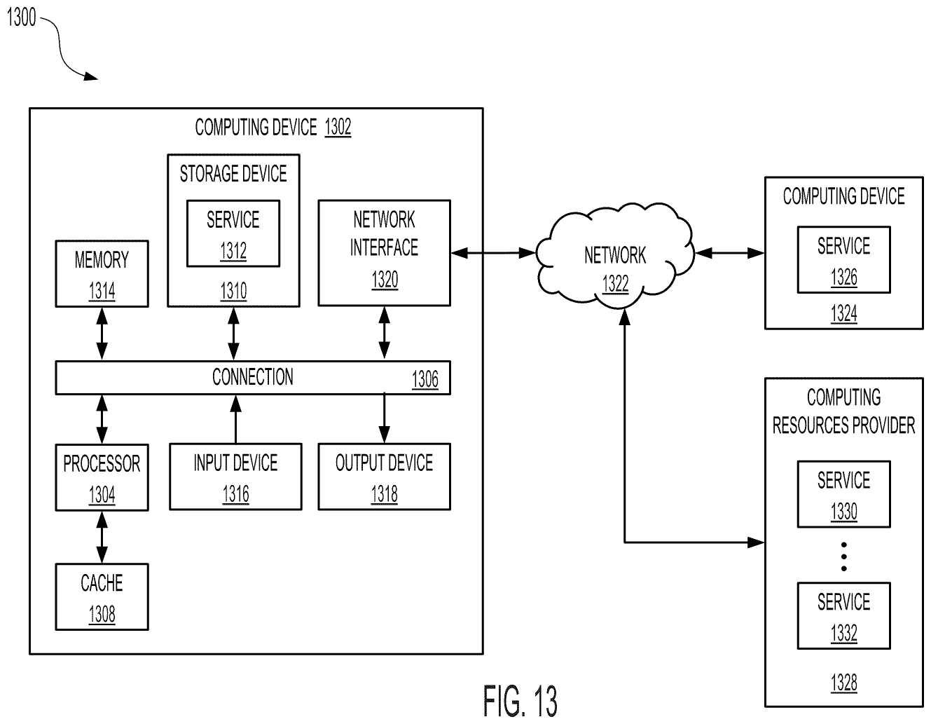

FIG. 13 illustrates a computing system architecture 1300, including various components in electrical communication with each other, in accordance with some embodiments. The example computing system architecture 1300 illustrated in FIG. 13 includes a computing device 1302, which has various components in electrical communication with each other using a connection 1306, such as a bus, in accordance with some implementations. The example computing system architecture 1300 includes a processing unit 1304 that is in electrical communication with various system components, using the connection 1306, and including the system memory 1314. In some embodiments, the system memory 1314 includes read-only memory (ROM), random-access memory (RAM), and other such memory technologies including, but not limited to, those described herein. In some embodiments, the example computing system architecture 1300 includes a cache 1308 of high-speed memory connected directly with, in close proximity to, or integrated as part of the processor 1304. The system architecture 1300 can copy data from the memory 1314 and/or the storage device 1310 to the cache 1308 for quick access by the processor 1304. In this way, the cache 1308 can provide a performance boost that decreases or eliminates processor delays in the processor 1304 due to waiting for data. Using modules, methods and services such as those described herein, the processor 1304 can be configured to perform various actions. In some embodiments, the cache 1308 may include multiple types of cache including, for example, level one (L1) and level two (L2) cache. The memory 1314 may be referred to herein as system memory or computer system memory. The memory 1314 may include, at various times, elements of an operating system, one or more applications, data associated with the operating system or the one or more applications, or other such data associated with the computing device 1302.

Other system memory 1314 can be available for use as well. The memory 1314 can include multiple different types of memory with different performance characteristics. The processor 1304 can include any processor and one or more hardware or software services, such as service 1312 stored in storage device 1310, configured to control the processor 1304 as well as a special-purpose processor where software instructions are incorporated into the actual processor design. The processor 1304 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1304 can be a microprocessor, a microcontroller, a digital signal processor (“DSP”), or a combination of these and/or other types of processors. In some embodiments, the processor 1304 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1300, an input device 1316 can represent any number of input mechanisms, such as a microphone for speech, a touch-sensitive screen for gesture or graphical input, keyboard, mouse, motion input, pen, and other such input devices. An output device 1318 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1300. In some embodiments, the input device 1316 and/or the output device 1318 can be coupled to the computing device 1302 using a remote connection device such as, for example, a communication interface such as the network interface 1320 described herein. In such embodiments, the communication interface can govern and manage the input and output received from the attached input device 1316 and/or output device 1318. As may be contemplated, there is no restriction on operating on any particular hardware arrangement and accordingly the basic features here may easily be substituted for other hardware, software, or firmware arrangements as they are developed.

In some embodiments, the storage device 1310 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1310 can include hardware and/or software services such as service 1312 that can control or configure the processor 1304 to perform one or more functions including, but not limited to, the methods, processes, functions, systems, and services described herein in various embodiments. In some embodiments, the hardware or software services can be implemented as modules. As illustrated in example computing system architecture 1300, the storage device 1310 can be connected to other parts of the computing device 1302 using the system connection 1306. In an embodiment, a hardware service or hardware module such as service 1312, that performs a function can include a software component stored in a non-transitory computer-readable medium that, in connection with the necessary hardware components, such as the processor 1304, connection 1306, cache 1308, storage device 1310, memory 1314, input device 1316, output device 1318, and so forth, can carry out the functions such as those described herein.

The disclosed processes for implementing the workforce optimization service can be performed using a computing system such as the example computing system illustrated in FIG. 13, using one or more components of the example computing system architecture 1300. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for implementing the workforce optimization service described herein by, for example, executing code using a processor such as processor 1304 wherein the code is stored in memory such as memory 1314 as described herein. One or more of a user device, a provider server or system, a database system, or other such devices, services, or systems may include some or all of the components of the computing system such as the example computing system illustrated in FIG. 13, using one or more components of the example computing system architecture 1300 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1328. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1304 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1314 can be coupled to the processor 1304 by, for example, a connector such as connector 1306, or a bus. As used herein, a connector or bus such as connector 1306 is a communications system that transfers data between components within the computing device 1302 and may, in some embodiments, be used to transfer data between computing devices. The connector 1306 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 1314 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1314 can also include magnetic or optical data storage media including read-only (e.g., CD ROM and DVD ROM) or otherwise (e.g., CD or DVD). The memory can be local, remote, or distributed.

As described above, the connector 1306 (or bus) can also couple the processor 1304 to the storage device 1310, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1310. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1306 can also couple the processor 1304 to a network interface device such as the network interface 1320. The interface can include one or more of a modem or other such network interfaces including, but not limited to those described herein. It will be appreciated that the network interface 1320 may be considered to be part of the computing device 1302 or may be separate from the computing device 1302. The network interface 1320 can include one or more of an analog modem, Integrated Services Digital Network (ISDN) modem, cable modem, token ring interface, satellite transmission interface, or other interfaces for coupling a computer system to other computer systems. In some embodiments, the network interface 1320 can include one or more input and/or output (I/O) devices. The I/O devices can include, by way of example but not limitation, input devices such as input device 1316 and/or output devices such as output device 1318. For example, the network interface 1320 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™ SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1302 can be connected to one or more additional computing devices such as computing device 1324 via a network 1322 using a connection such as the network interface 1320. In such embodiments, the computing device 1324 may execute one or more services 1326 to perform one or more functions under the control of, or on behalf of, programs and/or services operating on computing device 1302. In some embodiments, a computing device such as computing device 1324 may include one or more of the types of components as described in connection with computing device 1302 including, but not limited to, a processor such as processor 1304, a connection such as connection 1306, a cache such as cache 1308, a storage device such as storage device 1310, memory such as memory 1314, an input device such as input device 1316, and an output device such as output device 1318. In such embodiments, the computing device 1324 can carry out the functions such as those described herein in connection with computing device 1302. In some embodiments, the computing device 1302 can be connected to a plurality of computing devices such as computing device 1324, each of which may also be connected to a plurality of computing devices such as computing device 1324. Such an embodiment may be referred to herein as a distributed computing environment.

The network 1322 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1322 can be wired connections, wireless connections, or combinations thereof. Communications via the network 1322 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIF S), and other such communications protocols.

Communications over the network 1322, within the computing device 1302, within the computing device 1324, or within the computing resources provider 1328 can include information, which also may be referred to herein as content. The information may include text, graphics, audio, video, haptics, and/or any other information that can be provided to a user of the computing device such as the computing device 1302. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1302 and presented to a user of the computing device 1302 using forms that are perceptible via sight, sound, smell, taste, touch, or other such mechanisms. In some embodiments, communications over the network 1322 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1302 and/or the computing device 1324 can be connected to a computing resources provider 1328 via the network 1322 using a network interface such as those described herein (e.g. network interface 1320). In such embodiments, one or more systems (e.g., service 1330 and service 1332) hosted within the computing resources provider 1328 (also referred to herein as within “a computing resources provider environment”) may execute one or more services to perform one or more functions under the control of, or on behalf of, programs and/or services operating on computing device 1302 and/or computing device 1324. Systems such as service 1330 and service 1332 may include one or more computing devices such as those described herein to execute computer code to perform the one or more functions under the control of, or on behalf of, programs and/or services operating on computing device 1302 and/or computing device 1324.

For example, the computing resources provider 1328 may provide a service, operating on service 1330 to store data for the computing device 1302 when, for example, the amount of data that the computing device 1302 exceeds the capacity of storage device 1310. In another example, the computing resources provider 1328 may provide a service to first instantiate a virtual machine (VM) on service 1332, use that VM to access the data stored on service 1332, perform one or more operations on that data, and provide a result of those one or more operations to the computing device 1302. Such operations (e.g., data storage and VM instantiation) may be referred to herein as operating “in the cloud,” “within a cloud computing environment,” or “within a hosted virtual machine environment,” and the computing resources provider 1328 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1328 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1330 and service 1332 may implement versions of various services (e.g., the service 1312 or the service 1326) on behalf of, or under the control of, computing device 1302 and/or computing device 1324. Such implemented versions of various services may involve one or more virtualization techniques so that, for example, it may appear to a user of computing device 1302 that the service 1312 is executing on the computing device 1302 when the service is executing on, for example, service 1330. As may also be contemplated, the various services operating within the computing resources provider 1328 environment may be distributed among various systems within the environment as well as partially distributed onto computing device 1324 and/or computing device 1302.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1302) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), microprocessors, an application specific integrated circuits (ASICs), field programmable logic arrays (FPGAs), or other equivalent integrated or discrete logic circuitry. Such a processor may be configured to perform any of the techniques described in this disclosure. A processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 8-12). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1302.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
querying historical data associated with an organization to retrieve data corresponding to amounts of organizational exhaustion amongst one or more employees associated with the organization, wherein the historical data includes quantitative values corresponding to the amounts of organizational exhaustion amongst the one or more employees;
aggregating the data corresponding to the amounts of organizational exhaustion amongst the one or more employees associated with the organization to generate aggregated data;
training a machine learning algorithm, wherein the machine learning algorithm is trained using the historical data and historical recommendations for mitigating organizational exhaustion associated with the organization, and wherein the historical recommendations correspond to historical amounts of organizational exhaustion associated with the organization;
generating one or more recommendations for reducing the amounts of organizational exhaustion associated with the one or more employees, wherein the one or more recommendations are generated using the aggregated data as input to the machine learning algorithm; and
updating the machine learning algorithm, wherein the machine learning algorithm is updated based on the one or more recommendations and changes to the amounts of organizational exhaustion associated with the one or more employees.

2. The computer-implemented method of claim 1, further comprising:
processing in real-time communications associated with the one or more employees to determine a set of sentiments associated with the communications; and
normalizing the set of sentiments to generate a subset of the quantitative values.

3. The computer-implemented method of claim 1, further comprising:
obtaining in real-time service events associated with the one or more employees;
calculating a set of scores corresponding to the service events; and
normalizing the set of scores according to an impact to the organizational exhaustion to generate a subset of the quantitative values.

4. The computer-implemented method of claim 1, further comprising:
obtaining data corresponding to personal time-off benefit requests and to responses to the personal time-off benefit requests;
calculating a set of scores corresponding to the personal time-off benefit requests and the responses; and
normalizing the set of scores according to an impact to the organizational exhaustion to generate a subset of the quantitative values.

5. The computer-implemented method of claim 1, wherein the quantitative values represent employee states, wherein the employee states represent the organizational exhaustion, and wherein the employee states are used to define qualitative descriptors that provide indications of the amounts of organizational exhaustion amongst the one or more employees.

6. The computer-implemented method of claim 1, further comprising:
generating the quantitative values, wherein the quantitative values are generated based on events associated with the one or more employees, and wherein the quantitative values are generated using a second machine learning algorithm trained using historical events corresponding to employee behavior.

7. The computer-implemented method of claim 1, wherein:
the data corresponds to a time range for determining the amounts of organizational exhaustion associated with the one or more employees; and
the computer-implemented method further comprises calculating the amounts of organizational exhaustion over the time range to aggregate the data.

8. A system, comprising:
one or more processors; and
memory storing thereon instructions that, as a result of being executed by the one or more processors, cause the system to:
query historical data associated with an organization to retrieve data corresponding to amounts of organization exhaustion amongst one or more employees associated with the organization, wherein the historical data includes quantitative values corresponding to the amounts of organizational exhaustion amongst the one or more employees;
aggregate the data corresponding to the amounts of organizational exhaustion amongst the one or more employees associated with the organization to generate aggregated data;
train a machine learning algorithm, wherein the machine learning algorithm is trained using the historical data and historical recommendations for mitigating organizational exhaustion associated with the organization, wherein the historical recommendations correspond to historical amounts of organizational exhaustion associated with the organization;
generate one or more recommendations for reducing the amounts of organizational exhaustion associated with the one or more employees, wherein the one or more recommendations are generated using the aggregated data as input to the machine learning algorithm; and
update the machine learning algorithm, wherein the machine learning algorithm is updated based on the one or more recommendations and changes to the amounts of organizational exhaustion associated with the one or more employees.

9. The system of claim 8, wherein the instructions further cause the system to:
process in real-time communications associated with the one or more employees to determine a set of sentiments associated with the communications; and
normalize the set of sentiments to generate a subset of the quantitative values.

10. The system of claim 8, wherein the instructions further cause the system to:
obtain in real-time service events associated with the one or more employees;
calculate a set of scores corresponding to the service events; and
normalize the set of scores according to an impact to the organizational exhaustion to generate a subset of the quantitative values.

11. The system of claim 8, wherein the instructions further cause the system to:
obtain data corresponding to personal time-off benefit requests and to responses to the personal time-off benefit requests;
calculate a set of scores corresponding to the personal time-off benefit requests and the responses; and
normalize the set of scores according to an impact to the organizational exhaustion to generate a subset of the quantitative values.

12. The system of claim 8, wherein the quantitative values represent employee states, wherein the employee states represent the organizational exhaustion, and wherein the employee states are used to define qualitative descriptors that provide indications of the amounts of organizational exhaustion amongst the one or more employees.

13. The system of claim 8, wherein the instructions further cause the system to:
generate the quantitative values, wherein the quantitative values are generated based on events associated with the one or more employees, and wherein the quantitative values are generated using a second machine learning algorithm trained using historical events corresponding to employee behavior.

14. The system of claim 8, wherein:
the data corresponds to a time range for determining the amounts of organizational exhaustion associated with the one or more employees; and
the instructions further cause the system to calculate the amounts of organizational exhaustion over the time range to aggregate the data.

15. A non-transitory, computer-readable storage medium storing thereon executable instructions that, as a result of being executed by one or more processors of a computer system, cause the computer system to:
query historical data associated with an organization to retrieve data corresponding to amounts of organizational exhaustion amongst one or more employees associated with the organization, wherein the historical data includes quantitative values corresponding to the amounts of organizational exhaustion amongst the one or more employees;
aggregate the data corresponding to the amounts of organizational exhaustion amongst the one or more employees associated with the organization to generate aggregated data;
train a machine learning algorithm, wherein the machine learning algorithm is trained using the historical data and historical recommendations for mitigating organizational exhaustion associated with the organization, wherein the historical recommendations correspond to historical amounts of organizational exhaustion associated with the organization;
generate one or more recommendations for reducing the amounts of organizational exhaustion associated with the one or more employees, wherein the one or more recommendations are generated using the aggregated data as input to the machine learning algorithm; and
update the machine learning algorithm, wherein the machine learning algorithm is updated based on the one or more recommendations and changes to the amounts of organizational exhaustion associated with the one or more employees.

16. The non-transitory, computer-readable storage medium of claim 15, wherein the executable instructions further cause the computer system to:
process in real-time communications associated with the one or more employees to determine a set of sentiments associated with the communications; and
normalize the set of sentiments to generate a subset of the quantitative values.

17. The non-transitory, computer-readable storage medium of claim 15, wherein the executable instructions further cause the computer system to:
obtain in real-time service events associated with the one or more employees;
calculate a set of scores corresponding to the service events; and
normalize the set of scores according to an impact to the organizational exhaustion to generate a subset of the quantitative values.

18. The non-transitory, computer-readable storage medium of claim 15, wherein the executable instructions further cause the computer system to:
obtain data corresponding to personal time-off benefit requests and to responses to the personal time-off benefit requests;
calculate a set of scores corresponding to the personal time-off benefit requests and the responses; and
normalize the set of scores according to an impact to the organizational exhaustion to generate a subset of the quantitative values.

19. The non-transitory, computer-readable storage medium of claim 15, wherein the quantitative values represent employee states, wherein the employee states represent the organizational exhaustion, and wherein the employee states are used to define qualitative descriptors that provide indications of the amounts of organizational exhaustion amongst the one or more employees.

20. The non-transitory, computer-readable storage medium of claim 15, wherein the executable instructions further cause the computer system to:
generate the quantitative values, wherein the quantitative values are generated based on events associated with the one or more employees, and wherein the quantitative values are generated using a second machine learning algorithm trained using historical events corresponding to employee behavior.

21. The non-transitory, computer-readable storage medium of claim 15, wherein:
the data corresponds to a time range for determining the amounts of organizational exhaustion associated with the one or more employees; and
the executable instructions further cause the computer system to calculate the amounts of organizational exhaustion over the time range to aggregate the data.
